(19) United States
(12) Patent Application Publication
(10) Pub. No.: US 2024/0414594 A1
(43) Pub. Date: Dec. 12, 2024

(54) SLICE RESOURCE UTILIZATION MEASUREMENT

(71) Applicant: Dell Products, L.P., Round Rock, TX (US)

(72) Inventors: Satish Venkob, Mississauga (CA); Ali Esswie, Calgary (CA); Yongxia Lyu, Ottawa (CA)

(21) Appl. No.: 18/331,797

(22) Filed: Jun. 8, 2023

(51) Int. Cl. H04W 28/16; H04W 72/0457; H04W 72/53

(52) U.S. Cl. CPC H04W 28/16; H04W 72/0457; H04W 72/53

(57) ABSTRACT

A radio access network node may comprise a centralized unit and a distributed unit. The distributed unit may transmit to the centralized unit a status message comprising information elements indicative of utilization of bandwidth part slice radio resources. Based on the utilization information elements in the status message, the centralized unit may determine to reallocate bandwidth part resources from one bandwidth part to another. The centralized unit may instruct the distributed unit to implement a reallocation of the bandwidth part radio resources from the one bandwidth part to the other bandwidth part. The distributed unit may notify affected user equipment of the reallocation of bandwidth part radio resources.

### CROSS REFERENCE TO RELATED APPLICATION

The subject patent application is related by subject matter to, U.S. patent application Ser. No.______(docket number 133005.01/DELLP857US), filed Jun. 8, 2023, and entitled “DYNAMIC BANDWIDTH ASSIGNMENT OF RADIO SLICES,” the entirety of which application is hereby incorporated by reference herein.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise receiving, by a centralized function of a communication network from a distributed function of the communication network, a status message comprising a resource utilization indication corresponding to a resource slice and indicative of a utilization of at least one resource with respect to the resource slice. The centralized function may be referred to herein as a control function and the distributed function may be referred to herein as a distribution function. The method may further comprise analyzing, by the control function, the utilization of the at least one resource with respect to the resource slice to result in an analyzed utilization. Based on the analyzed utilization, the method may further comprise determining, by the control function, an allocation of the at least one resource with respect to the resource slice to result in a determined allocation. The method may further comprise transmitting, by the control function to the distribution function, an allocation message comprising a determined allocation indication indicative of the determined allocation, wherein the determined allocation is to be used to facilitate performing, by the distribution function, a resource assignment action. A radio access network node may comprise the control function and the distribution function, which may be implemented in a centralized unit and a distributed unit, respectively. The centralized unit may be referred to herein as a controller unit and the distributed unit may be referred to herein as a distribution unit. The control function may be implemented, for example, by a centralized unit or an nRT-RIC, and the distribution function may be implemented by a distributed unit.

In an embodiment, the at least one resource may be a physical resource block. In an embodiment, the at least one resource may be a portion of a physical resource block.

The resource slice may be a first resource slice, wherein the at least one resource is a first resource of the at least one resource corresponding to a first resource type associated with a first bandwidth part that facilitates the first resource slice, and wherein the determined allocation comprises a deactivation of the first resource of the at least one resource with respect to the first bandwidth part and an activation of a second resource of the at least one resource with respect to a second bandwidth part that facilitates a second resource slice. In an embodiment, the first resource and the second resource may be the same resource, for example a frequency resource or a time resource corresponding to one or more physical resource blocks. The resource assignment action may be specified to comprise generating, by the distribution function, a deactivation message, to be transmitted to at least one first user equipment corresponding to the first resource slice, indicative that the first resource of the at least one resource has been deactivated with respect to the first resource slice; and generating, by the distribution function, an activation message, to be transmitted to at least one second user equipment corresponding to the second resource slice, indicative that the second resource of the at least one resource has been activated with respect to the second resource slice. In an embodiment, the second resource of the at least one resource corresponds to a second resource type associated with the second bandwidth part, and wherein the first resource type and the second resource type are different. In an embodiment, the first resource of the at least one resource comprises at least one first physical resource block having a first size corresponding to the first bandwidth part, and wherein the second resource of the at least one resource comprises at least one second physical resource block having a second size corresponding to the second bandwidth part.

In an embodiment, the resource slice may be a first resource slice. A first bandwidth part may facilitate the first resource slice. A second bandwidth part may facilitate a second resource slice. The at least one resource may be sharable between the first bandwidth part and the second bandwidth part. In an embodiment, the control function and the distribution function may be components of a radio access network node of the communication network. In an embodiment, the control function may be a component of a radio access network node intelligent controller of the communication network.

In another example embodiment, a radio access network node may comprise a processor, configured to facilitate transmission of a status request message to a distribution function, and responsive to the status request message, receive, from the distribution function, a status message comprising a resource utilization indication corresponding to a resource slice and indicative of a utilization of radio resources with respect to the resource slice. The processor may be further configured to analyze the utilization of the radio resources with respect to the resource slice to result in an analyzed utilization. Based on the analyzed utilization, the processor may be further configured to determine an allocation of at least one resource of the radio resources with respect to the resource slice to result in a determined allocation and to facilitate transmission to a user equipment of a resource assignment action message that is based on the determined allocation. In an embodiment, the processor may correspond to a control function. The control function may be implemented by a centralized unit. In an embodiment, the status message may further comprise a capacity corresponding to the resource slice. The determined allocation may be further determined based on the capacity corresponding to the resource slice.

In an embodiment, the radio resources may be first radio resources, the resource slice may be a first resource slice, and the utilization of the radio resources with respect to the resource slice is a first utilization. The analyzed utilization may be a first analyzed utilization, the resource utilization indication may be a first resource utilization indication. The status message may further comprise a second resource utilization indication corresponding to a second resource slice and the status message may be indicative of a second utilization of second radio resources with respect to the second resource slice. The processor may be further configured to analyze the second utilization of at least one radio resource of the second radio resources with respect to the second resource slice to result in a second analyzed utilization, and the determined allocation may be further determined based on the second analyzed utilization. The status message may further comprise a first capacity corresponding to the first resource slice and a second capacity corresponding to the second resource slice. The determined allocation may be further determined based on the first capacity and the second capacity.

In yet another example embodiment, a non-transitory machine-readable medium may comprise executable instructions that, when executed by a processor of a radio access network node, facilitate performance of operations, comprising transmitting, by a control function to a distribution function, a status request message. Responsive to the status request message, the operations may comprise receiving, from the distribution function, a status message. The status message may comprise a first capacity indication indicative of a first radio resource capacity corresponding to a first bandwidth part and a first resource utilization indication indicative of a first radio resource utilization of first radio resources with respect to the first bandwidth part. The status message may further comprise a second capacity indication indicative of a second radio resource capacity corresponding to a second bandwidth part and a second resource utilization indication indicative of a second radio resource utilization of second radio resources with respect to the second bandwidth part. The operations may further comprise analyzing the first radio resource utilization and the first radio resource capacity with respect to a first usage criterion to result in an analyzed first utilization and analyzing the second radio resource utilization and the second radio resource capacity with respect to a second usage criterion to result in an analyzed second utilization. Based on the analyzed first utilization satisfying the first usage criterion (e.g., the first utilization is below a threshold indicative that the first radio resources are underutilized) and the analyzed second utilization failing to satisfy the second usage criterion (e.g., the second utilization exceeds a threshold indicative that the second bandwidth part is overutilized), determining an allocation of the radio resources. The operations may further comprise transmitting, to a first user equipment, a first resource assignment action message corresponding to the first radio resources; and transmitting, to a second user equipment, a second resource assignment action message corresponding to the first radio resources.

In an embodiment, the first resource assignment action message may comprise an indication that the first radio resources are to be deactivated with respect to the first bandwidth part, and the second resource assignment action message comprises an indication that the first radio resources are to be activated with respect to the second bandwidth part.

In an embodiment, the first usage criterion may satisfied by the first radio resource utilization being a first percentage of the first radio resources that is lower than the first usage criterion, and wherein the second usage criterion is satisfied by the second radio resource utilization being a second percentage of the second radio resources that is higher than the second usage criterion. In an embodiment, at least one of the first usage criterion or the second usage criterion may be a first percentage of utilization of the first radio resource capacity or a second percentage of utilization of the second radio resource capacity.

In an embodiment, the first radio resource capacity may be a first configured number of physical resource blocks usable by the first bandwidth part, and the second radio resource capacity may be a second configured number of physical resource blocks usable by the second bandwidth part. The first radio resource utilization of the first radio resources with respect to the first bandwidth part may be a first metric, or used number of the first configured number of physical resource blocks used by the first bandwidth part and the second radio resource utilization of the second radio resources with respect to the second bandwidth part may be a second metric, or used number of the second configured number of physical resource blocks used by the second bandwidth part.

### BRIEF DESCRIPTION OF THE DRAWINGS

FIG. 1 illustrates wireless communication system environment.

FIG. 2A illustrates an example environment with multiple user equipment in multiple groups of user equipment.

FIG. 2B illustrates an example environment with a dynamically assignable bandwidth part resource corresponding to a slice being assigned from one bandwidth part to another bandwidth part that has become heavily loaded.

FIG. 3 illustrates example bandwidth parts being assigned to different user equipment having different traffic characteristics.

FIG. 4 illustrates a dynamically assignable bandwidth part resource to be assigned from one bandwidth part to another bandwidth part.

FIG. 5 illustrates example explicit bandwidth part information that may be contained in a dynamic bandwidth part resource assignment indication.

FIG. 6 illustrates different bandwidth part patterns.

FIG. 7 illustrates a bandwidth part pattern having a downlink control channel resource.

FIG. 8 illustrates a timing diagram of an example embodiment method to dynamically share bandwidth part resources.

FIG. 9 illustrates a flow diagram of an example embodiment method to dynamically share bandwidth part resources.

FIG. 10 illustrates a block diagram of an example method embodiment.

FIG. 11 illustrates a block diagram of an example radio access network node.

FIG. 12 illustrates a block diagram of an example non-transitory machine-readable medium embodiment.

FIG. 13 illustrates an example computer environment.

FIG. 14 illustrates a block diagram of an example wireless user equipment.

FIG. 15A illustrates a distribution unit of a radio access network node transmitting a status message in response to a status message request received from a centralized unit.

FIG. 15B illustrates a distribution unit of a radio access network node transmitting an updated status message to a centralized unit.

FIG. 16 illustrates an example slice bandwidth part having multiple bandwidth part slices.

FIG. 17 illustrates example bandwidth part slice status message information.

FIG. 18 illustrates a flow diagram of an example method to determine utilization of bandwidth part slice radio resources.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

As an example use case that illustrates example embodiments disclosed herein, Virtual Reality (“VR”) applications and VR variants, (e.g., mixed and augmented reality) may at some time perform best when using NR radio resources associated with URLLC while at other times lower performance levels may suffice. A virtual reality smart glass device may consume NR radio resources at a given broadband data rate having more stringent radio latency and reliability criteria to provide a satisfactory end-user experience.

5G systems should support ‘anything reality’ (“XR”) services. XR services may comprise VR applications, which are widely adopted XR applications that provide an immersive environment which can stimulate the senses of an end user such that he, or she, may be ‘tricked’ into the feeling of being within a different environment than he, or she, is actually in. XR services may comprise Augmented Reality (‘AR’) applications that may enhance a real-world environment by providing additional virtual world elements via a user's senses that focus on real-world elements in the user's actual surrounding environment. XR services may comprise Mixed reality cases (“MR”) applications that help merge, or bring together, virtual and real worlds such that an end-user of XR services interacts with elements of his, or her, real environment and virtual environment simultaneously.

Different XR use cases may be associated with certain radio performance targets. Common to XR cases, and unlike URLLC or eMBB, high-capacity links with stringent radio and reliability levels are typically needed for a satisfactory end user experience. For instance, compared to a 5 Mbps URLLC link with a 1 ms radio budget, some XR applications need 100 Mbps links with a couple of milliseconds of allowed radio latency. Thus, 5G radio design and associated procedures may be adapted to the new XR QoS class and associated performance targets.

An XR service may be facilitated by traffic having certain characteristics associated with the XR service. For example, XR traffic may typically be periodic with time-varying packet size and packet arrival rate, but may also be sporadic, or bursty, in nature. In addition, different packet traffic flows of a single XR communication session may affect an end user's experience differently. For instance, a smart glass that is streaming 180-degree high-resolution frames may use a large percentage of a broadband service's capacity for fulfilling user experience. However, frames that are to be presented to a user's pose direction (e.g., front direction) are the most vital for an end user's satisfactory user experience while frames to be presented to a user's periphery vision have less of an impact on a user's experience and thus may be associated with a lower QoS requirement for transport of traffic packets as compared to a QoS requirement for transporting the pose-direction traffic flow. Therefore, flow differentiation that prioritizes some flows, or some packets, of a XR session over other flows or packets may facilitate efficient use of a communication system's capacity to deliver the traffic. Furthermore, XR capable devices (e.g., smart glasses, projection wearables, etc.) may be more power-limited than conventional mobile handsets due to the limited form factor of the devices. Thus, techniques to maximize power saving operation at XR capable device is desirable. Accordingly, a user equipment device accessing XR services, or traffic flows of an XR session, may be associated with certain QoS metrics to satisfy performance targets of the XR service in terms of perceived data rate or end to end latency and reliability, for example.

High-capacity-demanding services, such as virtual reality applications, may present performance challenges to even 5G NR capabilities. Thus, even though 5G NR systems may facilitate and support higher performance capabilities, the radio interface should nevertheless be optimized to support extreme high capacity and low latency requirements of XR applications and XR data traffic while minimizing power consumption.

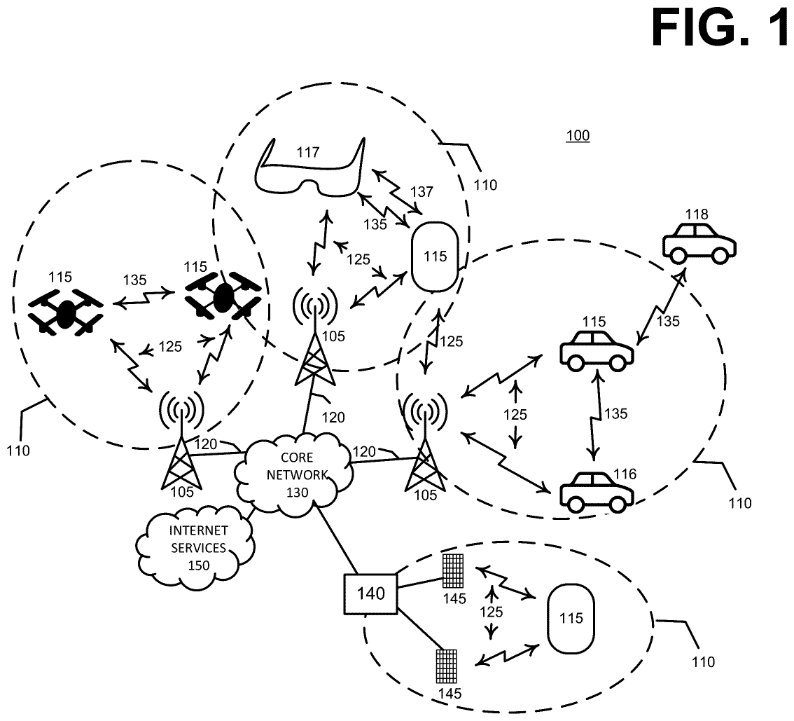

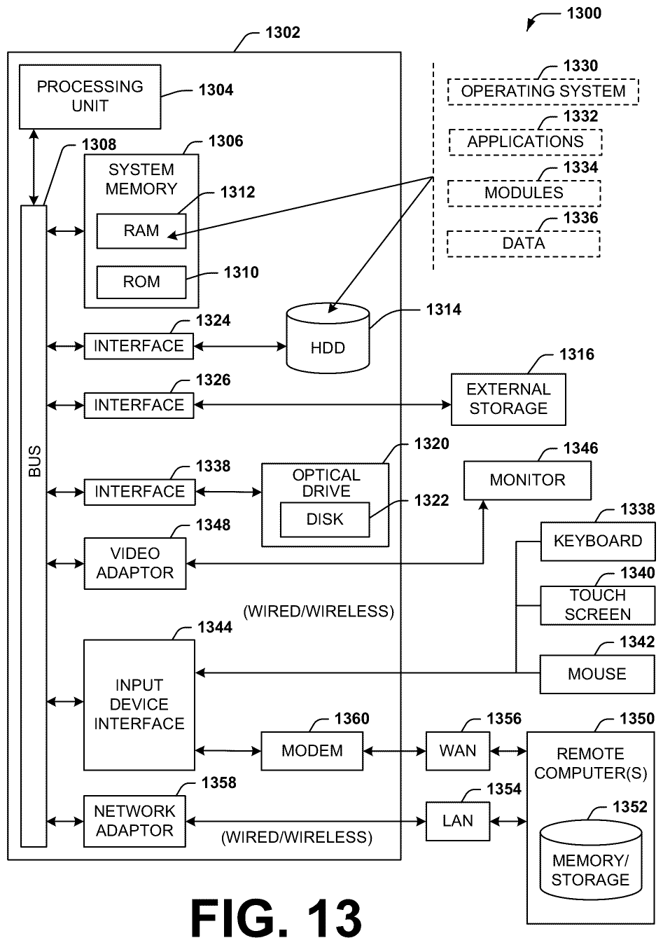

Turning now to the figures, FIG. 1 illustrates an example of a wireless communication system 100 that supports blind decoding of PDCCH candidates or search spaces in accordance with one or more example embodiments of the present disclosure. The wireless communication system 100 may include one or more base stations 105, one or more user equipment (“UE”) devices 115, and core network 130. In some examples, the wireless communication system 100 may comprise a long-range wireless communication network, that comprises, for example, a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 13.

Continuing with discussion of FIG. 1, base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (eg., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one component carrier, or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The performance of a communication network in providing an XR service may be at least partially determined according to satisfaction of a user of the XR services. Each XR-service-using user device may be associated with certain QoS metrics to satisfy the performance targets of the user's service, in terms of perceived data rate, end-to-end latency, and reliability.

A 5G NR radio system typically comprises a physical downlink control channel (“PDCCH”), which may be used to deliver downlink and uplink control information to cellular devices. The 5G control channel may facilitate operation according to requirements of URLLC and eMBB use cases and may facilitate an efficient coexistence between such different QoS classes.

Bandwidth Split into Parts

A radio access network, comprising, for example, a 5G NR network node, may implement Bandwidth Part (“BWP”) technology. BWP technology may be implemented by dividing a range of frequencies, or bandwidth, that has been assigned to, or allocated to, a carrier, a gNode B, or a carrier's signaling from and to a gNodeB, into multiple smaller bandwidth subsets, or frequency subranges, such that a subset, or subrange, may be ‘seen’ as a whole communication bandwidth that can be used by a user equipment for communication with a gNodeB/RAN node. From a user equipment perspective, a single configured BWP may be considered the whole available RAN/cell bandwidth, which includes frequency and time resources for data, control, and reference signals. For example, an available bandwidth of 100 MHz may be divided into ten smaller subsets, or subranges, of 10 MHz, with each 10 MHz subrange being referred to as a bandwidth part. A RAN node can configure multiple BWPs for use by different active user equipment devices, or different groups of user equipment devices, with each BWP being used to support radio characteristics corresponding to the BWP, the characteristics including bandwidth level, subcarrier spacing or supported antenna modes. As currently implemented, RAN node may typically configure up to four different BWPs, each having resources facilitating communication in the downlink and uplink directions. However, only a single BWP can be active at a time. This limitation is imposed due to limited processing capabilities of both the network and user equipment devices simultaneously monitoring and receiving multiple BWPs of different radio characteristics.

BWP technology may facilitate performance benefits, such as, for example power saving gain by a user equipment that may be realized by the user equipment scanning, monitoring, or decoding the smaller bandwidth range of the BWP instead of scanning, monitoring, and decoding the larger whole cell bandwidth that may be allocated to a mobile network operator (“MNO”)/carrier with which the user equipment has been provisioned for operation. In other words, a user equipment may be configured to tune its radio functions to communicate with a RAN node using frequency and time resources of a BWP, thus the user equipment may not expend processing resources or power resources in scanning the entire range of frequencies allocated to the MNO/carrier. User equipment devices are typically configured to always scan a configured available frequency range/bandwidth for multiple reasons including maintaining synchronization with the RAN node radio interface and to periodically check the user equipment device is camped on the best possible cell/RAN node, or beam thereof, with respect to signal strength coverage. The spectrum of frequencies that may be used for 5G NR communication is significantly greater than a spectrum allocated for, and used by, older mobile communication generations (e.g., LTE, 4G, 3G, etc.), and a frequency range, or spectrum, allocated to a given MNO/carrier for 5G NR operation can span hundreds of MHz. Having to scan an entire 5G NR MNO range by a user equipment would impose a severe processing load on a user equipment device. Thus, having a smaller-sized BWP configured for user equipment facilitates a user equipment device having reduced processing load by only scanning the bandwidth of the configured BWP instead of the entire bandwidth allocated to the MNO/carrier for which the user equipment is configured. Regarding grouping, user equipment devices can be grouped and configured, for example, with the same BWP based on having common quality of service requirements. Accordingly, a BWP configured for a group can be configured with radio aspects and radio resources that are suitable for performance requirements common to devices of the group. For example, a BWP, serving latency-critical devices, is likely to be configured with a larger subcarrier spacing to allow for faster transmissions.

Another benefit of implementing BWP technology is that user equipment devices may be grouped into sets of user equipment devices that share configured BWP resources based on quality-of-service requirements or functionalities that are common among the user equipment devices that are members of the set, or group, of user equipment. A RAN node may configure multiple BWPs with corresponding different radio resource setups, or arrangements.

A radio access network node may configure user equipment devices receiving critical traffic to use a stringent BWP (e.g., a BWP configured with large subcarrier spacing, advanced MIMO transmissions, mini-slot scheduling trading off the increased control overhead for faster radio transmissions, etc.) while user equipment receiving best effort traffic can be grouped to receive traffic according to a best effort BWP (e.g., a BWP having longer transmission periodicity, and advanced device multiplexing techniques trading off the degraded radio latency and reliability for boosted BWP capacity, etc.), thus maximizing overall network capacity and resource usage efficiency.

However, for use cases, such as XR services, traffic may be composed of multiple flows having different performance targets. For example, for XR view-port dependent streaming, an XR video streaming traffic session has a pose traffic flow (with packets feeding the pose direction of VR appliance, for example) with very stringent latency and reliability target compared to other traffic flows carrying traffic for peripheral/side positions of a VR appliance (e.g., a flow with packets feeding edges to facilitate the immersive viewing experience), and which may have relaxed latency and reliability requirement compared to a traffic flow carrying packets directed to a pose portion of a VR appliance due to human nature observing delays and packet drops in a pose portion more than in edge portions of an appliance.

For network deployments having large bandwidth of hundreds of MHz, a group of user equipment may be configured to scan a frequency portion (e.g., a BWP) and to receive or transmit radio signals thereto. Therefore, a BWP can be sufficiently defined, designed, or tuned, to radio requirements of user equipment to which the BWP is assigned. For example, a BWP used for traffic having low latency and high reliability requirements reliable BWP may be implemented with a larger subcarrier spacing (“SCS”), a shorter scheduling periodicity, and further reliability enhancements as compared to a BWP that may be assigned to user equipment that are conducting communication session primarily comprising best effort traffic. Thus, BWP technology may facilitate spectrum slicing of a radio interface.

However, using conventional/existing techniques, definition and adaptation of available BWPs is restricted and semi-static in nature. When a radio access network node determines to increase the bandwidth of a heavily-used BWP at the expense of reducing the bandwidth of another lightly-used BWP, the radio access network node may re-configure all active user equipment devices corresponding to all active BWPs associated with the radio access network node with updated configurations of all possible BWPs that take into account the new bandwidth allocations. This may lead to an increased latency of BWP adaptation and dynamic scheduling limitations. Conventional techniques cannot adapt a BWP bandwidth and corresponding configurations to temporarily accommodate latency-critical and sporadic packet arrivals at a transmitting device which may be a user equipment or a radio access network node. When a radio access network node uses conventional techniques to change a BWP bandwidth and to change configurations corresponding to all BWPs associated with the radio access network node consumes significant signaling overhead which may lead to increases in latency that may violate a latency budget corresponding to a user device. Furthermore, all active user equipment devices corresponding to all available BWPs associated with the radio access network node are impacted due to being updated with new BWP configurations, even for user equipment devices assigned to use BWPs that are not directly changed by the updated BWP configurations. Accordingly, embodiments disclosed herein facilitate dynamic BWP bandwidth sharing or assignment procedures. According to embodiments disclosed herein, a radio access network node May implement faster dynamic determinations by a traffic scheduler based on determining resource loading of each of multiple active BWPs. According to embodiments disclosed herein, a radio access network node can dynamically and immediately, or almost immediately, share or reassign a subset of a lightly loaded BWP with a highly loaded BWP. Therefore, using embodiments disclosed herein, only user equipment devices corresponding to, or assigned to use, BWPs that are changed are re-configured with new BWP bandwidth configurations, which may include a shared/reassigned bandwidth subset, or subsets, while User equipment devices assigned to use other BWPs are not impacted because Updated configuration information it's not transmitted thereto. This disclosed herein may comprise new downlink signaling, new BWP configurations (by defining multiple possible BWP-specific resource sharing patterns), and/or a new downlink control channel, which may be specific to a BWP, and via which new dynamic bandwidth reassignment control information is carried. Embodiments disclosed here in may facilitate BWP resource sharing configurations that facilitate the RAN node in dynamically reassigning a determined size of resources (e.g., a block of Bandwidth having a defined frequency range and time range) from a source BWP to a target BWP, depending on the need of the target BWP, and Depending on resource utilization of the source BWP. Thus, BWPs and associated fast BWP bandwidth adaptation procedures disclosed herein may facilitate slice-awareness over the radio interface.

Unlike with existing/conventional BWP schemes that only enable defining of multiple BWPs with each having a radio setup that is appropriate for traffic characteristics corresponding to traffic of interest (e.g., high-capacity traffic is served over high-capacity BWP with advanced transmission antenna capabilities but with relaxed latency/reliability), embodiments disclosed herein may facilitate a resource-slice-aware radio interface based on dynamic bandwidth part (BWP) adaptation. Existing BWP procedures do not allow for fast resource adaptation and scheduling among the different defined BWPs (e.g., in case of two available BWPs, one to be useable for low latency traffic and the other for high-capacity traffic, a radio access network node may determine that the BWP usable for low latency is partially loaded while the BWP usable for high-capacity traffic is overloaded. According to conventional techniques the radio access network node redefines all available BWPs and transmits an updated BWP configuration globally (e.g., to all active user equipment corresponding to all available bandwidth parts associated with the radio access network node) before the radio access network node can reallocate some of the resources from the partially loaded BWP towards the overloaded BWP. Such global updating of bandwidth part configuration is latency-inefficient and signaling-overhead-inefficient. A resource-slice-aware radio interface based on dynamic bandwidth part (BWP) adaptation as disclosed herein reduces inefficiencies and performance reduction caused by implementation of conventional techniques.

To facilitate dynamic bandwidth part adaptation, reassignment, or reallocation, by a scheduler of a distribution unit of a radio access network node, a scheduler of a centralized unit (“CU”), or a scheduler at a non-real-time radio access network node intelligent controller (“nRT-RIC”), embodiments disclosed herein may facilitate performing measurements related to availability utilization of radio resources to a bandwidth part slice. The terminology ‘controller nit’ may be used herein to refer to a CU or a cRT-RIC. Conventional techniques only facilitate an overall slice available capacity that may be a value that is calculated from multiple resource parameters corresponding to capacity at a distribution unit, for example, a value that is based on memory, processor loading, and transport capacity. To facilitate dynamic re-assignment or reallocation or bandwidth part slice radio resources, specific radio capacity related measurements, embodiments disclosed herein facilitate per slice, per bandwidth part, per shareable slice radio capacity measurement and reporting. By defining shareable resource areas corresponding to a bandwidth part that is serving a slice, radio resource can be used more efficiently by reallocating/reassigning the shareable resources between different bandwidth part s according to utilization or available capacity of the different bandwidth parts. It will be appreciated that sharable resources of a bandwidth part may be referred to as a slice of bandwidth part. Thus, a sharable bandwidth part slice may be shared between different bandwidth parts, which bandwidth parts may facilitate, or may even be referred to themselves, as slices, of an overall bandwidth corresponding to a service provider. Thus, embodiments disclosed herein facilitate determining utilization of radio resources corresponding to a slice of a bandwidth part. Embodiments disclosed herein may facilitate reallocation or reassignment determinations being made at a centralized unit, nRT-RIC, or other application that may be distinct from a distribution unit.

A user equipment device may receive physical downlink shared channel (“PDSCH”) and physical downlink control channel (“PDCCH”) messages and transmit physical uplink shared channel (“PUSCH”) and physical uplink control channels (“PUCCH”) only according to configured active DL and UL active BWP resources, respectively. A radio access network node may use dedicated and common radio resource control signaling (“RRC”) signaling, including the signal information blocks (SIB1), to configure multiple BWPs. Typically, a single BWP is active for each UE. A UE may receive and transmit only according to active BWP that the user equipment Is configured to use. A radio access network node can switch an active BWP using a BWP indicator field within a downlink control information (“DCI”). Each BWP can be configured with a different subcarrier spacing, cyclic prefix, and different time and frequency ranges. Thus, a radio interface spectrum may be divided into multiple slices and each of the slices may be supported by, or facilitated by, resources corresponding to a bandwidth part that are different from bandwidth part resources that are defined for a different bandwidth part.

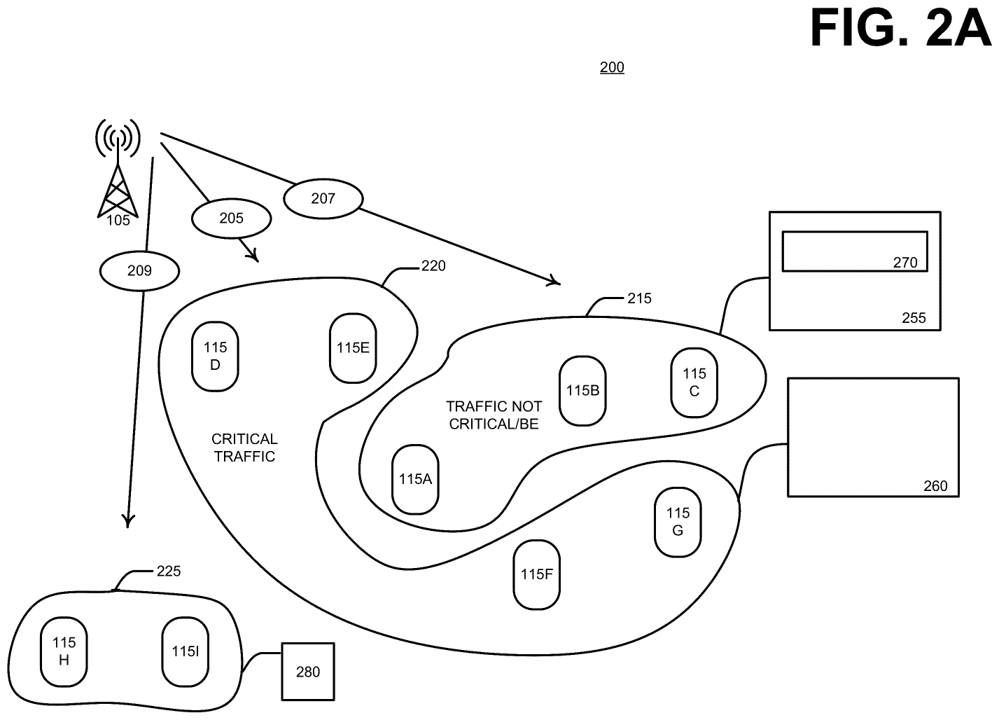

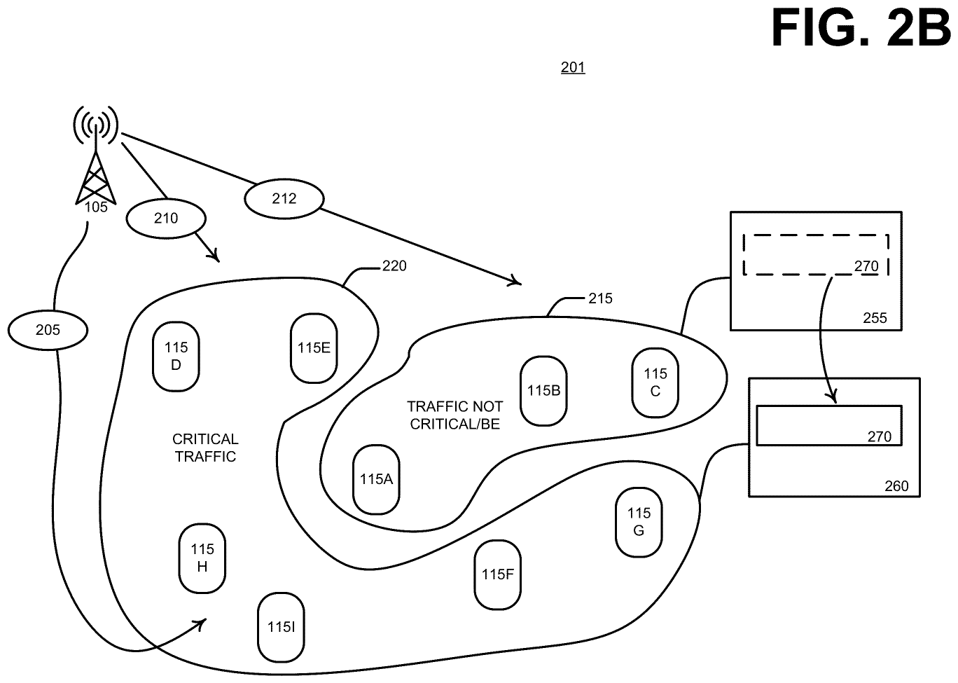

Turning now to FIG. 2A, the figure illustrates an example environment 200 with multiple user equipment 115 in multiple user equipment groups 215, 220, and 225. Group 215 may comprise user equipment 115A, 115B, and 115C. User equipment of group 215 may be grouped together because they are not operating communication sessions that comprise critical traffic. Thus, for example, radio access network node 105 may configure, via configuration 205, user equipment of group 220 to communicate traffic with the radio access network node, for example to receive downlink traffic from the radio access network node, according to BWP 260, and the radio access network node may configure, via a configuration 207, user equipment of group 215 to communicate with the radio access network node, for example to receive downlink traffic from the radio access network node, according to BWP 255. In an embodiment, configuration 207 may comprise an indication indicative that sharable (e.g., assignable between bandwidth parts 260 and 255) bandwidth resource 270 may be usable by user equipment of group 215. In an embodiment, a bandwidth part resource assignment indication indicative that radio access network node 105 has granted sharable/assignable resource 270 to user equipment of group 215 may be transmitted separately from configuration 207. User equipment of group 220 may be currently conducting communication sessions with radio access network node 105 that comprise critical traffic, for example traffic having a stringent latency requirement or traffic having a high reliability requirement comprising packets that are not to be discarded. User equipment group 225 may comprise user equipment 115H and 1151 configured via configuration 209 to use BWP 280.

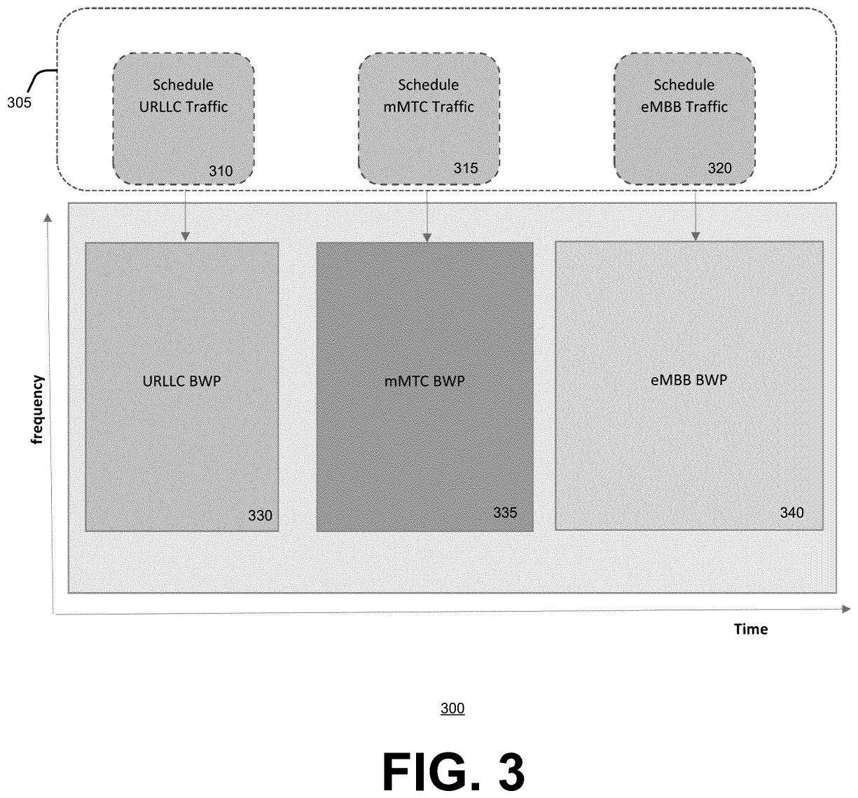

A radio access network node can configure different active BWPs for different network slices and a scheduler at the radio access network node can schedule resources of a spectrum slice to implement a bandwidth part corresponding to the spectrum slice. Bandwidth part assignment 300 illustrated in FIG. 3 depicts spectrum slice resources being scheduled and allocated for use in facilitating communication of traffic 305. Traffic 305 may comprise ultra-reliable and low latency (URLLC) traffic 310 and is shown being facilitated via resources corresponding to URLLC BWP 330. Communication of enhanced mobile broadband (eMBB) traffic 315 is shown being facilitated via resources corresponding to eMBB BWP 335, and communication of massive machine type communication (mMTC) traffic 320 is shown being facilitated via resources corresponding to mMTC BWP 340. Each BWP 330, 335, and 340 comprises a different block of time and frequency resources as shown in BWP assignment 300.

However, according to conventional techniques, bandwidth parts may not efficiently perform network slice-aware bandwidth part resource scheduling due to lack of capability to dynamically reallocate resources from a bandwidth part supporting one network resource slice to another bandwidth part supporting another network resource slice. For example, if a RAN node configures three bandwidth parts, each to support URLLC, eMBB and mMTC slices, respectively, and if the BWP serving the URLLC slice is not utilized fully (e.g., usage of physical resource blocks (“PRB”) allocated within the BWP is below a certain threshold), then resources from the underutilized BWP could be reallocated to a different BWP that may have different radio settings (e.g., different subcarrier spacing “SCS”, different antenna capability, etc.) and that may be supporting another slice that is heavily loaded (e.g., a percentage of PRBs allocated to the heavily-loaded BWP exceeds a parameter threshold criterion). However, according to conventional techniques, such reallocations would require use of very slow RRC signaling (e.g., slow as compared to downlink control information (“DCI”) signaling) to reconfigure bandwidth part definitions at all user equipment being served by the radio access network node. Conventional techniques do not facilitate reassigning sharable bandwidth part resources at Level 2/Media Access Control and Distributed Unit scheduler levels without notifying all user equipment, even user equipment that are unaffected by a bandwidth part resource reassignment, of a reassignment. According to conventional techniques, reconfiguration of a BWP (e.g., a time-based location and bandwidth range, a SCS, or a cyclic prefix) requires Level 3 RRC signaling, which precludes use of fast dynamic reallocations (e.g., reallocation capable of being performed within a few milliseconds).

Embodiments disclosed herein facilitate shareable bandwidth resources within slice bandwidth parts that correspond to resource slices. The shareable resources can be reallocated, or reassigned, from a bandwidth part supporting one slice of radio resources to a bandwidth part supporting another slice of radio resource in a dynamic manner and as a scheduler determination using faster DCI signaling messaging. A determination to reassign sharable resources may be made based on resource usage of various resource slices.

### Dynamic Bandwidth Assignment of Radio Slice Resources

Using embodiments disclosed herein, a RAN node may continuously monitor resource loading levels corresponding to all active bandwidth parts facilitated by the RAN. On condition of determining a lightly-loaded source BWP, where the resource utilization is below, for example, a predefined utilization ratio threshold, and determining a highly-loaded BWP, where the resource utilization is above a predefined threshold, the RAN node may trigger dynamic BWP resource reassignment or sharing. The RAN node may first determine an appropriate size, or amount, of the lightly-loaded BWP resources to be dynamically re-assigned, and may append the determined resources to the highly-loaded BWP. Reassigned resources may be referred to as sharable resources. The RAN node may transmit a novel BWP resource removal indication, which may be referred to as a bandwidth part resource assignment indication, towards active user equipment devices assigned to the source BWP (e.g., the lightly-loaded BWP), via a specially configured BWP-specific control channel or via device-specific control channels corresponding to the user equipment devices. The removal indication may be indicative that the reassigned sharable resources have been suspended with respect to user equipment using the source BWP for a resource sharing period. The RAN node may transmit a novel append indication, which may also be referred to as a bandwidth part resource assignment indication, towards active user equipment devices assigned to the target BWP (e.g., the heavily-loaded BWP), via the specially configured BWP-specific control channel or via device-specific control channels corresponding to the user equipment devices to indicate to the user equipment of the target BWP that the reassigned sharable resources are usable by the user equipment using the target BWP during the resource sharing period. A bandwidth part resource assignment indication may facilitate user equipment devices to dynamically adjust bandwidth use corresponding to a currently-assigned BWP (e.g., target BWP or source BWP), and according adjust decoding behavior with respect to reference signals, data resources, and control channel resources corresponding to the user equipment devices' respective BWPs. In an embodiment, a bandwidth part resource assignment indication may be explicit, in terms of timing and frequency information of the removed/reassigned resources from the source BWP to the target BWP. In an embodiment, a bandwidth part resource assignment indication may be implicit, wherein a BWP resource pattern index, corresponding to one or more BWP patterns configured in a bandwidth part configuration, is indicated in the bandwidth part resource assignment indication and a user equipment that receives the implicit bandwidth part resource assignment indication determine the sharable resources that have been suspended of appended by looking up a BWP pattern in the bandwidth part configuration that corresponds to the index include in the implicit bandwidth part resource assignment indication.

Dynamically shared BWP resources can be returned back to a source BWP based on another bandwidth part resource assignment indication transmitted from a RAN node, or after a pre-configured expiry period, which may be referred to a resource sharing period, expires. Using an expiry timer may result in a reduction in signaling overhead as compared to affirmatively transmitting another bandwidth part resource assignment indication to indication that the reassigned resources are to revert back to being assigned to the source BWP. Accordingly, using embodiments disclosed herein, a RAN node may facilitate dynamically, and on-the-go, sharing of resources from one BWP to another, depending on resource loading and quality of service (QoS) fulfillment corresponding to each of the BWPs, which may be referred to a slice-aware radio adaptation. A RAN node may facilitate scheduler-driven BWP bandwidth adaptation and reassignment of bandwidth resources corresponding to a lightly-loaded BWP, or a BWP supporting best effort traffic, to an overloaded BWP, or a BWP supporting critical traffic, with only user equipment using the lightly-loaded or overloaded bandwidth parts being notified of the sharing of sharable resources between the lightly-loaded and the overloaded bandwidth parts.

Turning now to FIG. 2B, the figure illustrates environment 201 where, compared to environment 200 shown in FIG. 2A, user equipment 115H and 1151 are now part of group 220 and may be conducting a communication session with radio access network node 105 that comprises critical traffic that may have a low latency requirement or a high reliability requirement. Since user equipment 115H and 1151 are now part of group 220, radio access network node 105 may transmit to user equipment 115H and 1151 configuration 205 which may comprise an indication for user equipment 115H and 1151 to use bandwidth part 260 to communicate with the radio access network node. However, after user equipment 115H and 1151 become part of group 220, BWP 260 may become more heavily used/loaded such that static resources corresponding to BWP 260 may not satisfactorily support traffic characteristic requirements (e.g., latency, reliability or other QoS requirement) corresponding to group 220. Accordingly, radio access network node 105 may transmit to at least one user equipment of group 220 a bandwidth part resource assignment indication 210 indicative that the radio access network node has granted a grant of sharable resource(s) 270 to at least one user equipment of group 220. Radio access network node 105 may determine to assign sharable resource 270 to bandwidth part 260 and to suspend, or revoke, the grant, or assignment, of shareable resources 270 to bandwidth part 255 based on traffic characteristics corresponding to user equipment of group 215, for example, the traffic corresponding to group 215 being best effort traffic, and based on traffic corresponding to group 220 being critical traffic (e.g., traffic having a low latency requirement or a high reliability requirement). In FIG. 2B, sharable/assignable resource(s) 270 is/are illustrated with dashed lines within bandwidth part 255 and is/are illustrated with solid lines within bandwidth part 260 to illustrate that the shareable/assignable resource(s) has been assigned to bandwidth part 260 and has been unassigned, revoked, or suspended with respect to bandwidth part 255. Radio access network node 105 may transmit to user equipment of group 215 a bandwidth part resource assignment indication 212 indicative that the radio access network node has revoked, or suspended, the grant of the at least one resource 270 to at least one user equipment of group 215.

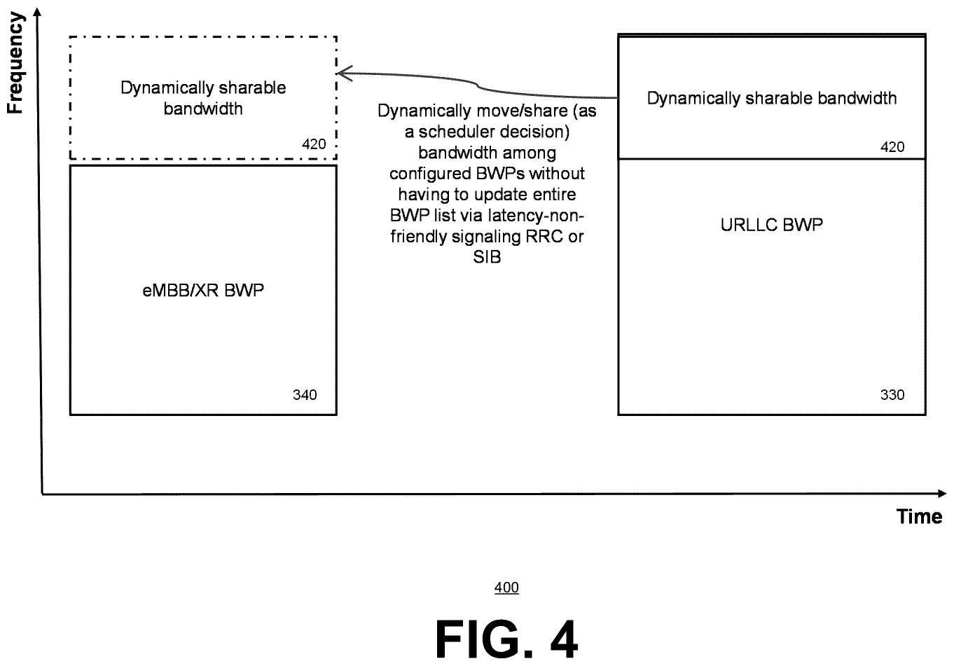

Turning now to FIG. 4, the figure illustrates a novel dynamic BWP bandwidth assignment 400. A RAN node may first determine a lightly loaded BWP having a resource utilization ratio below a predefined threshold. For example, ultra-reliable and low-latency communication (“URLLC”) BWP 330 may be a lightly loaded BWP due to the sporadic URLLC traffic arrivals at a transmitter. Thus, occasionally, there may not be many URLLC packet arrivals and URLLC BWP 330 may exhibit resource underutilization. However, enhanced mobile broadband (eMBB) BWP 340, which may be contending with extreme capacity demands with traffic arrivals that are more regular and that may require more resources than BWP 330. Thus, a RAN node operating BWPs 330 and 340 may dynamically schedule the sharing of a determined size of URLLC BWP resources 330, for example sharable resources 420, towards overloaded eMBB BWP 340 to boost traffic handling capacity thereof. Such dynamic resource sharing can be conditioned on a configured expiry period or based on subsequent dynamic resource configurations.

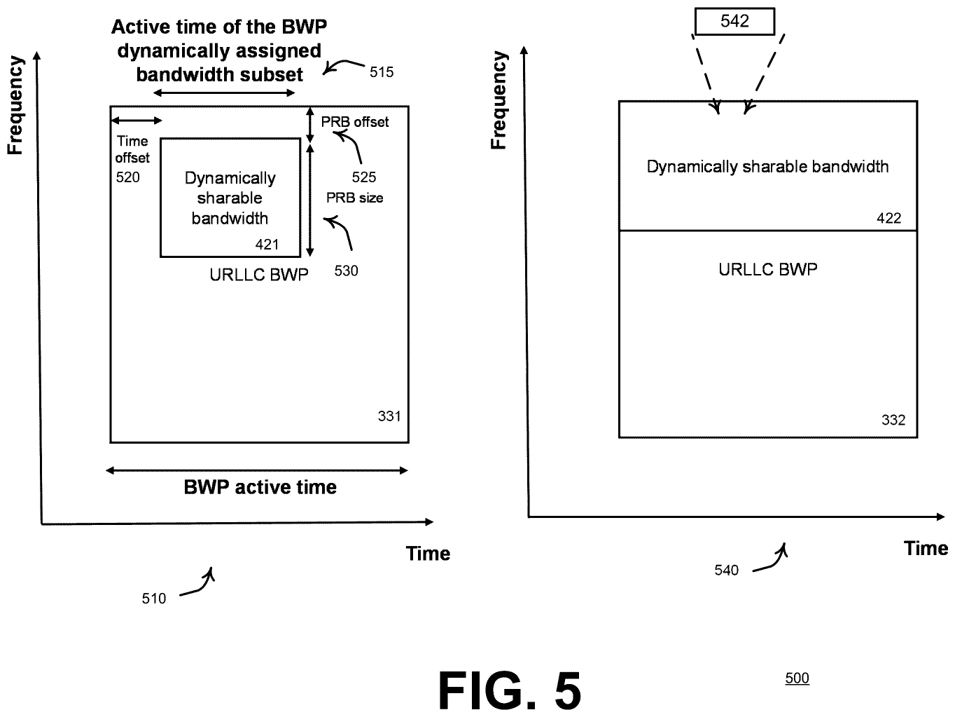

As illustrated in FIG. 5, indication of dynamic resource sharing information to user equipment devices corresponding to a source BWP and a target BWP may be facilitated via explicit timing and frequency information corresponding to resource subset 421 to be shared from source towards target BWPs. BWP dynamic resource sharing information may comprise information elements including a physical resource block size indication and physical resource block indices defining frequency resource size and location of a subset of a bandwidth part that are sharable, or assignable, or that are to be shared or assigned, from one BWP (e.g., a source BWP) to another BWP (e.g., a target BWP). A dynamic resource sharing information element may comprise an active time indication 515 corresponding to a period corresponding to bandwidth part pattern 510 during which sharable, or to be shared, bandwidth resources 421 are usable by a user equipment to which bandwidth part 331 has been assigned and to which bandwidth part shareable bandwidth resources 421 have been assigned. A dynamic resource sharing information element may comprise a time offset 520 indication indicative of a beginning time of sharable bandwidth resources 421. A dynamic resource sharing information element may comprise a PRB offset indication 525 or a PRB size, or range, indication 530 indicative of a frequency range within bandwidth part 331 that is usable by a user equipment using bandwidth part 331 to which shareable bandwidth resources 421 have been assigned.

Bandwidth part resource pattern 540 and bandwidth part resource pattern 510 illustrate different bandwidth parts 331 and 332, respectively, having different-sized sharable/assignable resources 422 and 421, respectively. Instead of a dynamic resource sharing information element comprising an active time indication 515, a time offset indication 520, a PRB offset indication 525, or a PRB range indication 530, a dynamic resource sharing information element may comprise an index, or identifier, 542, corresponding to sharable/to-be-shared resources 422 of bandwidth part 332, that a user equipment may use to look up in a configuration, such as a configuration 205 or configuration 207 described in reference to FIG. 2A, a bandwidth part pattern, or a bandwidth part sharable resource pattern, that may define activated shareable bandwidth resources, usable for communicating traffic with the radio access network node. Thus, in an embodiment, explicit dynamic resource sharing information, that may include explicit offset and range information as shown in FIG. 5 relative to bandwidth pattern 510, may be communicated from a radio access network node to a user equipment via an update message, for example bandwidth part resource assignment indication message 210 described in reference to FIG. 2B. In an embodiment, implicit dynamic resource sharing information may be transmitted in a message 210 or 212 that comprises an index, such as index 542 shown relative to bandwidth pattern 540 comprising bandwidth part 332 in FIG. 5, to indicate to a user equipment a pattern of bandwidth part resources, or a pattern of shareable/to-be-shared bandwidth part resources, usable by the user equipment. In addition, a bandwidth part resource assignment indication may comprise explicit or implicit dynamic resource sharing information indicative of sharable bandwidth part resources that have been suspended with respect to a bandwidth part, for example, bandwidth part resource assignment indication 212 described in reference to FIG. 2B may indicate that sharable resources 270 have been suspended with respect to bandwidth part 255.

A BWP dynamic resource sharing information element may comprise an active resource sharing active period indicating a period of time that may be implementer, for example, via a expiry timer during which shared or reassigned resources are specified to remain associated with a target BWP. The resource sharing active period may be a different period than period 515, during which sharable resources 421 within BWP 331 are usable by a user equipment configured to use bandwidth part pattern 510. After an active period of a bandwidth part pattern, or a bandwidth part sharable resource pattern, expires, shared bandwidth part resource may be assigned/reassigned back to the source BWP. Thus, a user equipment using a given BWP to communicate traffic may alter operation based on resources that may change according to assigning of, or suspending of, assignable/sharable resources indicated in a bandwidth part resource assignment indication message such as message 210 or message 212 shown in FIG. 2B. For example, user equipment of group 215 shown in FIG. 2B using source BWP 255, upon return of shared resource subset 270 from target BWP 260 back to the source BWP after expiration of an active period (e.g., a resource sharing period) corresponding to the sharable resources being associated with bandwidth part 260, may resume monitoring, and receiving, traffic according to previously configured resources (e.g., time and frequency resources corresponding to the returned bandwidth part resource subset 270) to decode downlink reference signals.

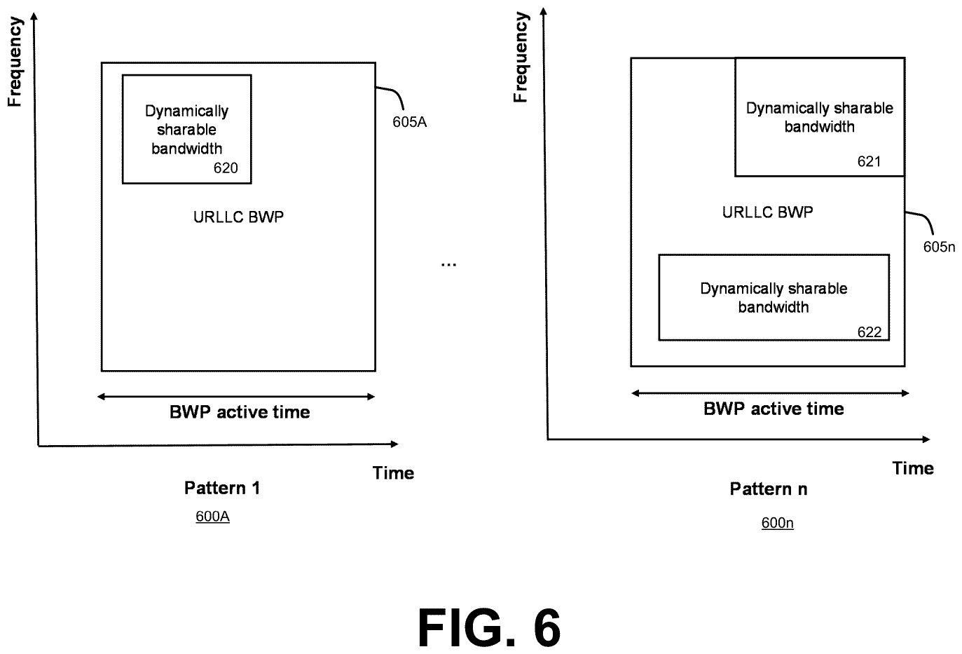

Turning now to FIG. 6, the figure illustrates multiple bandwidth part patterns 600A—600n. Bandwidth part 605A is shown with dynamically shareable bandwidth resources 620. Bandwidth part 605n, corresponding to bandwidth part pattern 600n, comprises dynamically shareable bandwidth resources 621 and dynamically shareable bandwidth resources 622, both of which resources 621 and 622 are different from dynamically shareable resources 620 corresponding to bandwidth part 605A. Thus, a configuration, such as a configuration 205 or 207 described in reference to FIG. 2A may comprise definitions of multiple bandwidth part patterns 600 as shown in FIG. 6 and a bandwidth part resource assignment indication message, such as a message 210 or 212 described in reference to FIG. 2B, may comprise an index corresponding to, and that is indicative of, a bandwidth part pattern 600A-600n according to which a user equipment may be specified to operate during an active resource sharing period corresponding to the bandwidth part pattern 600A-600n, which active resource sharing period may be indicated in a message 210 or 212 described in reference to FIG. 2B.

One or more resource patterns 600A-600n may be configured and associated with a BWP. A resource pattern 600A-600n may define certain timing and frequency resources within each BWP that may be dynamically shared or reassigned among different BWPs, based on a determination made by a scheduler at a radio access network node. Instead of transmitting explicit BWP resource removal and append information, the radio access network node may transmit just an index corresponding to a resource pattern comprising shareable resources specified to be shared or reassigned from a source BWP to a target BWP. A list of BWP-specific resource patterns may be configured (e.g., via a configuration 205 or 207 shown in FIG. 2A) using high-level signaling, for example via broadcast information or RRC signaling that may be semi-static signaling. A radio access network node can define multiple different sharable resource patterns of different sizes and validity periods as being associated with a BWP. Indications of sharing and reassignment of the resource patterns (e.g., bandwidth part resource assignment indication message, such as messages 210 or 212 shown in FIG. 2B) may be transmitted to user equipment via DCI signaling, which is typically faster and less overhead-intensive than RRC signaling.

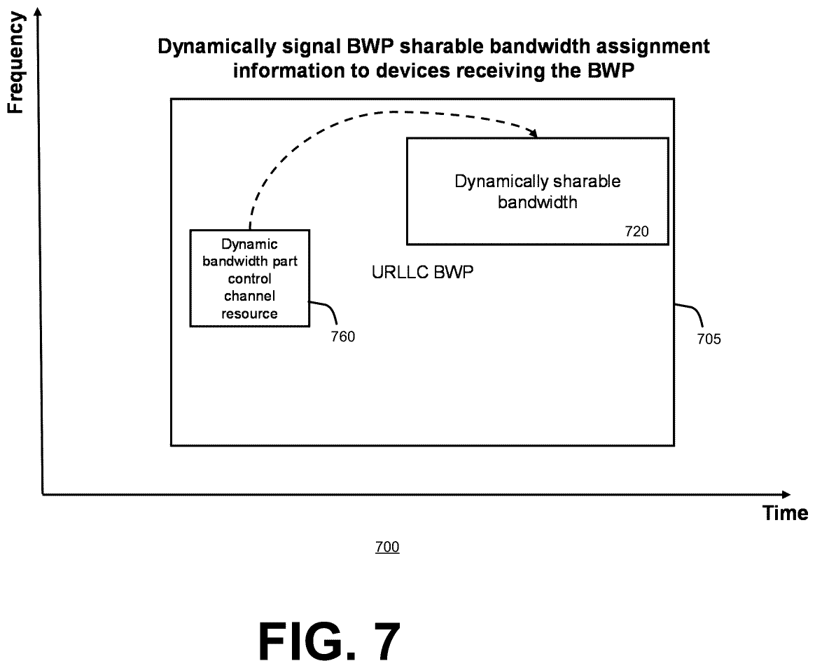

Turning now to FIG. 7, the figure illustrates example dynamic BWP resource sharing 700. A slice-common or BWP-common control channel 760 may be configured for active user equipment devices, configured to use BWP 705, to use to detect and decode dynamic resource sharing control information, such as a bandwidth part resource assignment indication message 210 or 212. Scrambling of control channel 760 may be device-common (e.g., specific to one or more specific user equipment such as UE 115A and 115B shown in FIG. 2A/2B), or group-specific (e.g., specific to, but usable by all of, user equipment of group 215 shown in FIG. 2A/2B). For device-specific scrambling, devices configured to use a BWP may monitor control channel 760 to determine potential dynamic sharable resource grant assignment or resource suspend/revoke information. However, for group-specific scrambling, only a subset of user equipment configured to use a BWP may monitor control channel 760. Group-specific scrambling may be useful when a scheduler at a RAN allows communication of multiple traffic flows corresponding to different QoS requirements via the same BWP, for example, XR and eMBB traffic may be facilitated by the same BWP configured to facilitate high capacity/high data-rate traffic flows. However, since one of QoS flow classes using a BWP may correspond to more stringent requirements than the other, a RAN scheduler may only schedule user equipment communicating the stringent traffic flows with BWP resources that are non-overlapping with sharable resource patterns. Thus, the user equipment operating the stringent traffic flows may not be impacted by dynamic resource sharing. However, other user equipment that are operating to communicate best effort traffic can be scheduled with resources that may overlap sharable resources of sharable resource, and the sharable resources may be dynamically shared, or re-assigned, to other BWPs for a sharing active period determined by the scheduler at the RAN. Thus, user equipment of a group that decode control channel 760 according to a group-specific scrambling code may be simultaneously notified that dynamically shareable bandwidth resources 720 may be deactivated for a period with respect to user equipment operating to communicate noncritical traffic while the dynamically shareable bandwidth resources 720 are activated during the period with respect to user equipment operating to communicate traffic having stringent quality of service requirements.

Accordingly, user equipment devices may monitor configured control channel 760 and determine the presence of the potential dynamic resource sharing information. On condition of decoding valid resource sharing information (explicit resource information or implicit resource pattern indications), user equipment devices may adapt decoding behavior accordingly. For example, when a user equipment device, configured to use bandwidth part 705 according to pattern 700, detects a bandwidth part resource assignment indication message via control channel 760 that is indicative of sharable bandwidth part resources 720 being suspended, and the shareable bandwidth part resources partially or fully overlap with resources configured according to a previous scheduling grant, the user equipment may assume that a current active resource grant is specified to be halted/stopped until the dynamically reassigned resources are returned back to BWP 705. The user equipment may determine when resources are returned back to being assigned to BWP 705 based on expiration of the active period of the dynamic resource sharing or upon receiving a subsequent bandwidth part resource assignment indication message indicative that shareable bandwidth part resources 720 have been reactivated with respect to bandwidth part 705 period. In other words, while shareable resources 720 are assigned to a different bandwidth part than bandwidth part 705, a user equipment configured to use bandwidth part 705 may not use frequency and time resources corresponding to dynamically shareable bandwidth resources 720.

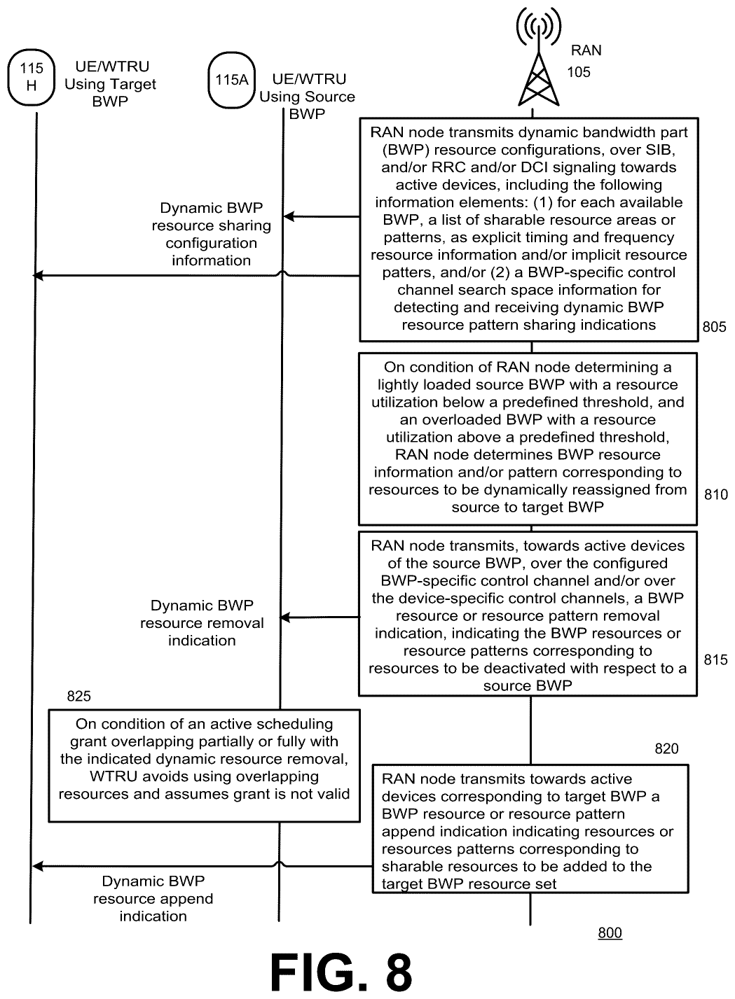

Turning now to FIG. 8, the figure illustrates a timing diagram of an example method 800 to facilitate sharing of sharable bandwidth part resources between a source bandwidth part and a target bandwidth part. At act 805, radio access network node 105 may configure UE 115A, via a source bandwidth part configuration, such as configuration 207 shown in FIG. 2A, defining the source bandwidth part. The source bandwidth part configuration may comprise at least one resource indication associated with at least one resource corresponding to at least one bandwidth part resource set that is available to be assigned. Also at act 805, radio access network node 105 may configure UE 115H, via a target bandwidth part configuration, such as configuration 205 shown in FIG. 2A, with a definition of the target bandwidth part. The target bandwidth part configuration definition may comprise at least one resource indication associated with at least one resource corresponding to at least one bandwidth part resource set that is available to be assigned.

RAN node 105 may transmit the target bandwidth part configuration or the source bandwidth part configuration via SIB, RRC, or DCI signaling to UE 115 or UE115H. The target bandwidth part configuration or the source bandwidth part configuration may comprise dynamic resource sharing information elements. A resource sharing information element may comprise, for each of one or more available BWPs, a list of sharable resources or sharable resource patterns, as explicit timing and frequency resource information or implicit resource pattern indication(s). A resource sharing information element of a target bandwidth part configuration or a source bandwidth part configuration may comprise BWP-specific control channel search space information (e.g., resource defining control channel 760 described in reference to FIG. 7) usable to detect and receive dynamic BWP resource pattern sharing indications, such as a bandwidth part resource assignment indication message, such as message 210 or 212 described in reference to FIG. 2B.

Continuing with description of FIG. 8, at act 810, on condition of RAN node 105 determining a light loading of source BWP resources (e.g., a resource utilization below a predefined threshold), and determining a high loading, or an overloading, of a target BWP (e.g., a resource utilization being above a predefined threshold), the RAN node may determine BWP resource sharing information, or a sharable resource pattern, corresponding to sharable bandwidth part resources to be dynamically reassigned from the source BWP to the target BWP.

At act 815, RAN node 105 may transmit toward active user equipment 115A (and other devices configured to use the source BWP) via the configured BWP-specific control channel, or via a device-specific control channel, a bandwidth part resource assignment indication, that may comprise an indication of removal/deactivation of the sharable BWP resource, either explicitly, or via a resource pattern index, for example, indicating that the sharable BWP resources are to be deactivated with respect to the source BWP during a resource sharing period.

At act 820, RAN node 105 may transmit, toward UE 115H configured to use the target BWP, (and to other use equipment that may be configured to use the target BWP), a bandwidth part resource assignment indication that may comprise a BWP resource or resource pattern append indication, indicating sharable resources, or resources patterns comprising sharable resources, to be shared with, or added to, the target BWP during the resource sharing period, which may be the same sharable period as indicated to UE 115A in the a bandwidth part resource assignment indication transmitted thereto at act 815.

At act 825, on condition of a scheduling grant of sharable resources shared from the source bandwidth part to the target bandwidth part partially or fully overlapping with resources that would otherwise be used by UE 115A, UE 115A may avoid receiving, or attempting to receive, traffic according to the overlapping resource(s) and may assume that the grant of the sharable resource(s) shared to the target BWP is not valid, at least during the resource sharing period.

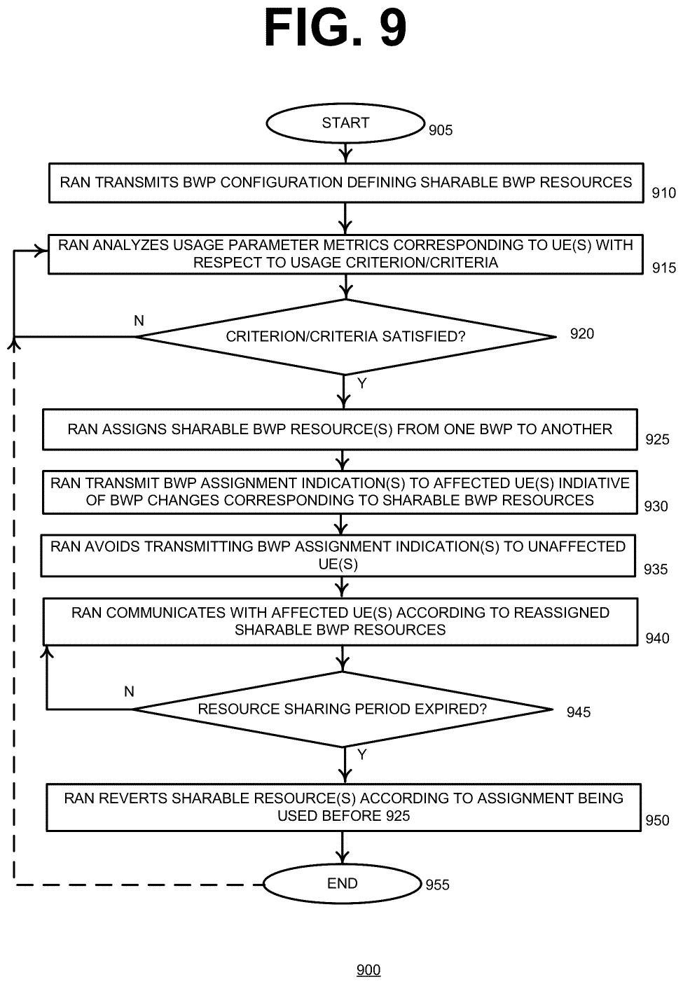

Turning now to FIG. 9, the figure illustrates a flow diagram of an example embodiment method 900 to dynamically share bandwidth part resources. Method 900 begins at act 905. At act 910, a radio access network node may transmit a bandwidth part configuration, for example configuration 205 or 207, as shown in FIG. 2A, to one or more user equipment. The one or more user equipment may make up, or compose, one or more different user equipment groups, for example groups 215, 220, or 225 as shown and described in reference to FIG. 2A. A configuration transmitted at act 910 shown in FIG. 9 may define one or more bandwidth part resources corresponding to one or more bandwidth parts, for example bandwidth parts 255, 260, or 280 shown in FIG. 2A. A configuration transmitted at act 910 shown in FIG. 9 may define bandwidth part shareable resources 270 as shown in FIG. 2A.

Continuing with description of FIG. 9, at act 915 the radio access network node may analyze one or more usage parameter metrics corresponding to user equipment. The usage parameter metrics may be analyzed with respect to the usage criterion, or usage criteria. A usage criterion, or usage criteria, may comprise a threshold percentage corresponding to a usage of physical resource blocks allocated to a bandwidth part to transport traffic that is transmitted or received according to resources defined in the configuration transmitted at act 910 as corresponding to the bandwidth part. A usage parameter metric may be a measurement, or determination, of a number of physical resource blocks being used to transport traffic according to a given bandwidth part. A usage parameter metric may be a measurement, or determination, of a number of physical resource blocks being used to transport traffic according to a given bandwidth part that is being used to facilitate a slice of radio resources. A usage parameter metric may be measured, or determined, by a distributed unit, or a distribution function, of a radio access network node, and may be transmitted to, or provided to, a control function, or a controller unit, (e.g., a CU) of the radio access network node in response to a status request message received from the control function by the distribution function. A distribution function may be facilitated by a distributed unit (“DU”). A distributed unit may be referred to as a distribution unit.

At act 920, the radio access network node may determine whether the usage criterion, or usage criteria, are satisfied by the determined, or measured, usage parameter metric(s). If the criterion, or criteria, are not satisfied, method 900 returns to act 915 and the radio access network node continues to analyze usage parameter metrics.

If a determination made at act 920 is that the usage parameter metric(s) satisfy the usage criterion, or usage criteria, at act 925 radio access network node may assign shareable bandwidth part resources, such as shareable resources 270 shown in FIG. 2B, from a one bandwidth part (which may be referred to as a source bandwidth part) to another bandwidth part (which may be referred to as a target bandwidth part), for example, from bandwidth 255 to bandwidth part 260.

Continuing with description of FIG. 9, at act 930 the radio access network node may transmit one or more bandwidth part assignment indications to affected user equipment devices. The bandwidth part assignment indications, such as, for example, indication messages 210 or 212 shown in FIG. 2B, may be indicative of bandwidth part changes corresponding to shareable bandwidth part resources. For example, user equipment of group 215 may be affected by a change to bandwidth part 255 because sharable bandwidth part resources 270 will not available for use by user equipment of group 215, at least during a resource sharing period that may have been indicated in an indication message 212. User equipment of group 220 may also be affected by the assignment of shareable bandwidth part resources 270 at act 925 shown in FIG. 9 because, at least during a resource sharing period that may have been indicated in message 210, shareable bandwidth part resources 270 have been assigned to, or appended to, bandwidth part 260, which may have been heavily loaded by user equipment of group 220, and shared bandwidth part resource may be usable by user equipment of group 220 during the resource sharing period.

Continuing with description of FIG. 9, at act 935, the radio access network node may avoid transmitting a bandwidth part assignment indication to user equipment that are not affected by the assignment, at act 925, of shareable resources from one bandwidth part (e.g., a source bandwidth part to another bandwidth part (e.g., a target bandwidth part). Thus, signaling overhead need not be used to notify user equipment that are not affected by assignment of sharable resources of a bandwidth part from one bandwidth part to another. User equipment that may be communicating with the radio access network node according to a bandwidth part other than a bandwidth part with respect to which shareable resources are either suspended or appended may not receive a bandwidth part assignment indication indicative of the sharing of shareable bandwidth part resources from one bandwidth part to another.

At act 940, transport of traffic between the radio access network node and user equipment affected by the assignment, or reassignment, of sharable bandwidth part resources at act 925 may be conducted. For example, one or more user equipment of group 220 shown in FIG. 2B may use shareable time or frequency resources 270 to communicate traffic with radio access network node 105 during a resource sharing period whereas user equipment of group 215 may refrain from using time or frequency resources corresponding to sharable resources 270 to communicate traffic with the radio access network node during the resource sharing period. At act 945, shown in FIG. 9, the radio access network node may determine whether a resource sharing period, which may have been indicated in a bandwidth part assignment indication transmitted at act 930, has expired. If the resource sharing period has not expired, method 900 returns to act 940 and the radio access network node may continue communicating traffic with one or more user equipment according to reassigned shareable bandwidth part resources. If a determination is made at act 945 that a resource sharing period indicated in a bandwidth part assignment indication transmitted at act 930 has expired, method 900 advances to act 950. At act 950, the radio access network node may revert shareable resources, for example resources 270 shown in FIG. 2B, from a target bandwidth part back to a source bandwidth part, for example from bandwidth part 260 back to being assigned to bandwidth part 255. After resources 270 have reverted back to bandwidth part 255, resources 270 may again be usable by user equipment of group 215 shown in FIG. 2A. After reverting of shared resources at act 950 shown in FIG. 9, method 900 advances to act 955 and ends. A dashed line is shown connecting ending act 955 back to act 915 to illustrate that acts 915-950 may be part of a continually executing loop.

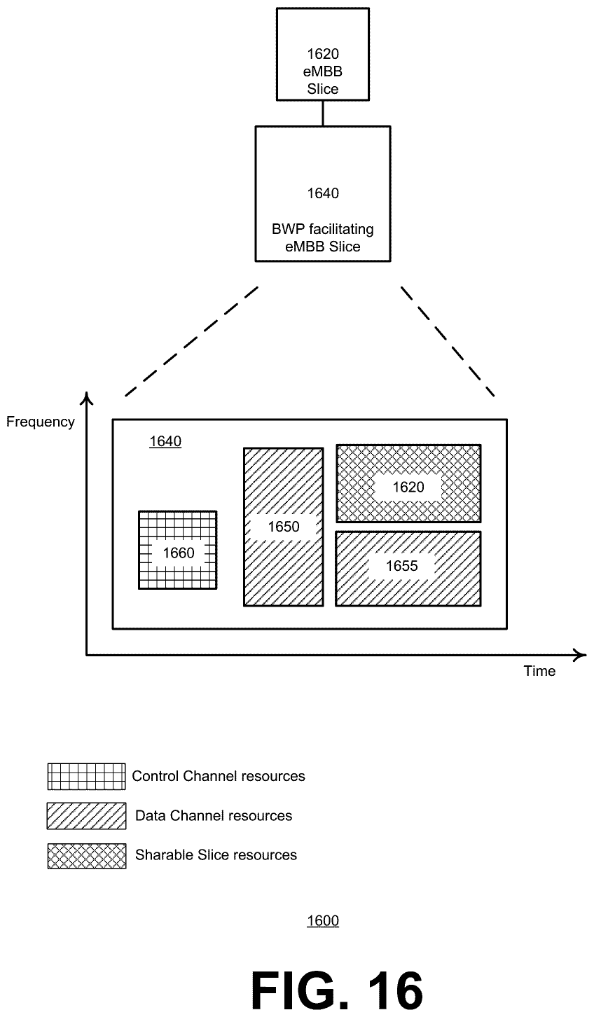

Turning now to FIG. 16, the figure illustrates an example bandwidth part slice implementation 1600. Arrangement 1600 comprises bandwidth part 1640. Bandwidth part 1640 may facilitate an expanded mobile broadband traffic slice 1620. Bandwidth part 1640 may comprise bandwidth part slices, for example control channel resource slides 1660, data channel resource slices 1650 and 1655, and sharable bandwidth part resources slice 1620. As described elsewhere herein, sharable bandwidth part resource slice 1620 may comprise one or more physical resource blocks. A radio access network node may determine a utilization of sharable bandwidth part resources slice 1620. Based on the determined utilization, the radio access network node may determine whether to share one or more physical resource blocks corresponding to shareable bandwidth part resources slice 1620.

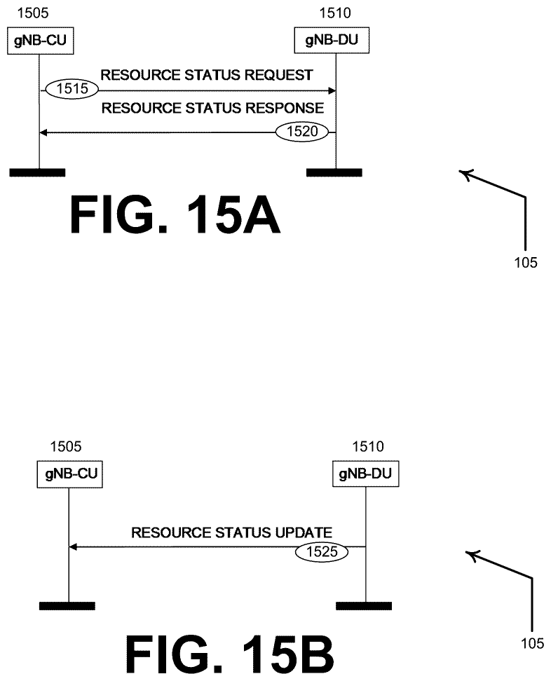

The utilization of physical resource blocks of shareable bandwidth part resources slice 1620 may be determined by a distributed unit 1510 of a radio access network node 105 shown in FIG. 15A. Distributed unit 1510 may transmit a status report message 1520 to centralized unit 1505 corresponding to radio access network node 105. Status message 1520 may be transmitted from distributed unit 1510 to centralized unit 1505 responsive to a status request message 1515 received by the distributed unit from the centralized unit. Distributed unit 1510 may transmit an resource status message 1525, which may comprise updated status information, to centralized unit 1505 unilaterally without having received a status request message as shown in FIG. 15B. A status message 1520, or an updated status message 1525, transmitted from distributed unit 1510 to centralized unit 1505 may comprise information elements as shown in Table 1. The four information elements shown in Table 1, starting at the eleventh row from the bottom, are highlighted with double borders, and correspond to a simplified illustration of example BWP resource slice resource information elements 1600 of status message 1520 as shown in FIG. 16. In Table 1, information elements, other than the four information elements that are highlighted, may comprise conventional information elements.

Sharing of radio resources among various slices can be achieved by defining shareable resource regions, such as region 1620 shown in FIG. 16, within slice-aware, or slice-supporting, BWPs via RRC signaling or via DCI signaling mechanisms. Shareable bandwidth part resource may be reallocated from one bandwidth part supporting a slice, such as a bandwidth part supporting eMBB, to another bandwidth part that is supporting another slice, for example a bandwidth part supporting URLLC, in a dynamic manner by a scheduler that may use DCI signaling messages (faster than a centralized unit making a determination and using RRC signaling to notify a UE of changes to bandwidth parts) based on resource utilization metrics corresponding to various slices (e.g., utilization of radio resources by the bandwidth parts facilitating the eMBB and URLLC traffic). According to embodiments disclosed herein, a distributed unit may provide per-slice per-bandwidth part slice utilization to a centralized unit or an nRT-RIC to facilitate continuous monitoring of resource loading levels of all active bandwidth parts serving all the slices.

TABLE 1

| | | | IE type | | | |
|---|---|---|---|---|---|---|
| | | | and | Semantics | | Assigned |
| E/Group Name | Presence | Range | reference | description | Criticality | Criticality |
| SSB Area Radio | | 1 | | | — | |
| Resource Status List | | | | | | |
| >SSB Area Radio | | 1 . . . | | | — | |
| Resource Status Item | | <maxnoofSSBAreas> | | | | |
| >>SSB Index | M | | INTEGER | | — | |
| | | | (0 . . . 63) | | | |
| >>SSB Area DL | M | | INTEGER | Per SSB area DL | — | |
| GBR PRB usage | | | (0 . . . 100) | GBR PRB usage in | | |
| | | | | percentage of the | | |
| | | | | cell total PRB | | |
| | | | | number. | | |
| >>SSB Area UL | M | | INTEGER | Per SSB area UL | — | |
| GBR PRB usage | | | (0 . . . 100) | GBR PRB usage in | | |
| | | | | percentage of the | | |
| | | | | cell total PRB | | |
| | | | | number. | | |
| >>SSB Area DL non- | M | | INTEGER | Per SSB area DL | — | |
| GBR PRB usage | | | (0 . . . 100) | non-GBR PRB usage | | |
| | | | | in percentage of | | |
| | | | | the cell total | | |
| | | | | PRB number. | | |
| >>SSB Area UL non- | M | | INTEGER | Per SSB area UL | — | |
| GBR PRB usage | | | (0 . . . 100) | non-GBR PRB usage | | |
| | | | | in percentage of | | |
| | | | | the cell total | | |
| | | | | PRB number. | | |
| >>SSB Area DL | M | | INTEGER | Per SSB area DL | — | |
| Total PRB usage | | | (0 . . . 100) | Total PRB usage | | |
| | | | | in percentage of | | |
| | | | | the cell total | | |
| | | | | PRB number. | | |
| >>SSB Area UL | M | | INTEGER | Per SSB area UL | — | |
| Total PRB usage | | | (0 . . . 100) | Total PRB usage | | |
| | | | | in percentage of | | |
| | | | | the cell total | | |
| | | | | PRB number. | | |
| >>DL scheduling | O | | INTEGER | | — | |
| PDCCH CCE usage | | | (0 . . . 100) | | | |
| >>UL scheduling | O | | INTEGER | | — | |
| PDCCH CCE usage | | | (0 . . . 100) | | | |
| Slice Radio | | 0 . . . 1 | | | YES | ignore |
| Resource List | | | | | | |
| >Slice Radio | | 1 . . . | | | — | |
| Resource Item | | <maxnoofBPLMNsNR> | | | | |
| >>PLMN Identity | M | | 9.3.1.14 | Broadcast PLMN | — | |
| >>S-NSSAI Radio | | 1 | | | — | |
| Resource Status List | | | | | | |
| >>>S-NSSAI Radio | | 1 . . . | | | — | |
| Resource Status Item | | < maxnoofSliceItems> | | | | |
| >>>>S-NSSAI | M | | 9.3.1.38 | | — | |
| >>>>S-NSSAI DL | M | | INTEGER | Per slice DL GBR PRB | — | |
| GBR PRB usage | | | (0 . . . 100) | usage in percentage | | |
| | | | | of the cell total | | |
| | | | | PRB number. | | |
| >>>>S-NSSAI UL | M | | INTEGER | Per slice UL GBR PRB | — | |
| GBR PRB usage | | | (0 . . . 100) | usage for this slice | | |
| | | | | in percentage of the | | |
| | | | | cell total PRB number. | | |
| >>>>S-NSSAI DL | M | | INTEGER | Per slice DL non-GBR | — | |
| non-GBR PRB usage | | | (0 . . . 100) | PRB usage for this | | |
| | | | | slice in percentage | | |
| | | | | of the cell total | | |
| | | | | PRB number. | | |
| >>>>S-NSSAI UL | M | | INTEGER | Per slice UL non-GBR | — | |
| non-GBR PRB usage | | | (0 . . . 100) | PRB usage for this | | |
| | | | | slice in percentage | | |
| | | | | of the cell total | | |
| | | | | PRB number. | | |
| >>>>Slice DL Total | M | | INTEGER | Total amount of DL | — | |
| PRB allocation | | | (0 . . . 100) | PRBs available per | | |
| | | | | cell for this slice | | |
| | | | | if all the resources | | |
| | | | | the slice could | | |
| | | | | access were usable. | | |
| >>>>Slice UL Total | M | | INTEGER | Total amount of UL | — | |
| PRB allocation | | | (0 . . . 100) | PRBs available per | | |
| | | | | cell for this slice | | |
| | | | | if all the resources | | |
| | | | | the slice could | | |
| | | | | access were usable. | | |
| >>>>Slice UL | | 1 . . . | | | | |
| Shareable Areas | | <maxNoofShareableAreasUL> | | | | |
| >>>>>Shareable | M | | INTEGER | Per slice per | | |
| Area PRB Usage | | | (0 . . . 100) | Shareable Area PRB | | |
| | | | | usage in percentage | | |
| | | | | of the total Shareable | | |
| | | | | Area PRB number. | | |
| >>>>Slice DL | | 1 . . . | | | | |
| Shareable Areas | | <maxNoofShareableAreasDL> | | | | |
| >>>>>Shareable | M | | INTEGER | Per slice per | | |
| Area PRB Usage | | | (0 . . . 100) | Shareable Area PRB | | |
| | | | | usage in percentage | | |
| | | | | of the total Shareable | | |
| | | | | Area PRB number. | | |
| MIMO PRB usage | O | | | | YES | ignore |
| Information | | | | | | |
| >DL GBR PRB | M | | INTEGER | Per cell DL GBR | — | |
| usage for MIMO | | | (0 . . . 100) | PRB usage for | | |
| | | | | MIMO in percentage | | |
| | | | | of the cell total | | |
| | | | | PRB number | | |
| >UL GBR PRB | M | | INTEGER | Per cell UL GBR | — | |
| usage for MIMO | | | (0 . . . 100) | PRB usage for | | |
| | | | | MIMO in percentage | | |
| | | | | of the cell total | | |
| | | | | PRB number | | |
| >DL non-GBR PRB | M | | INTEGER | Per cell DL non-GBR | — | |
| usage for MIMO | | | (0 . . . 100) | PRB usage for MIMO | | |
| | | | | in percentage of | | |
| | | | | the cell total | | |
| | | | | PRB number | | |
| >UL non-GBR PRB | M | | INTEGER | Per cell UL non-GBR | — | |
| usage for MIMO | | | (0 . . . 100) | PRB usage for MIMO | | |
| | | | | in percentage of | | |
| | | | | the cell total | | |
| | | | | PRB number | | |
| >DL Total PRB | M | | INTEGER | Per cell DL Total | — | |
| usage for MIMO | | | (0 . . . 100) | PRB usage for | | |
| | | | | MIMO in percentage | | |
| | | | | of the cell total | | |
| | | | | PRB number | | |
| >UL Total PRB | M | | INTEGER | Per cell UL Total | — | |
| usage for MIMO | | | (0 . . . 100) | PRB usage for | | |
| | | | | MIMO in percentage | | |
| | | | | of the cell total | | |
| | | | | PRB number | | |

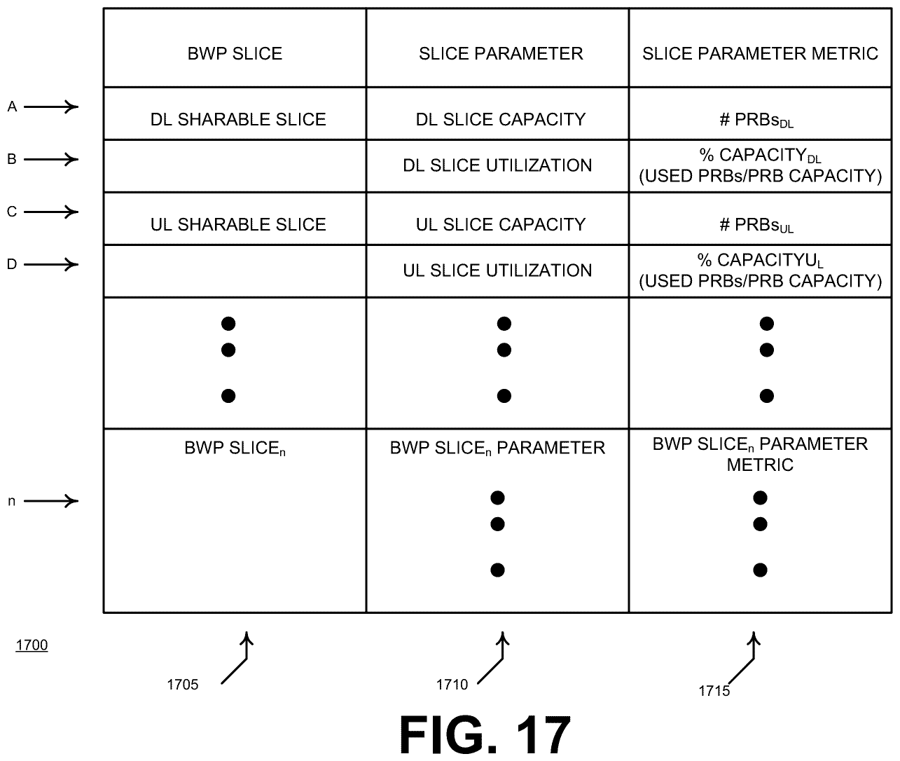

Turning now to FIG. 17, the figure illustrates example bandwidth part slice status message information 1700. Bandwidth part slice status message information 1700 may comprise bandwidth part slice identifier field 1705, slice parameter field 1710, and slice parameter metric field 1715. An entry in field 1705 may indicate resources corresponding to a bandwidth part slice, for example a shareable slice such as sharable slice 1620 shown in FIG. 16. If bandwidth part 1640 illustrated in FIG. 16 corresponds to bandwidth part resources allocated for downlink transmission from a radio access network node to one or more user equipment, sharable resources 1620 may correspond to downlink shareable resources that may be identified in field 1705A shown in FIG. 17. Identifier information in field 1705A may comprise an explicit definition of resources corresponding to shareable resources 1620, or identifier information in field 1705A may comprise implicit information, such as, for example, an index that corresponds to resources that define shareable resources 1620 in a bandwidth part configuration. Identifier information contained in field 1705 may comprise more than just information that identifies shareable bandwidth part resources.

Continuing with the example of sharable resources 1620 shown in FIG. 16 being downlink shareable resources, field 1710A and 1710B may comprise parameter information corresponding to slice resources associated with information contained in field 1705A. For example, field 1710A may comprise a capacity corresponding to downlink shareable slice resources corresponding to information identified in field 1705A. The slice capacity parameter indication in field 1710A may indicate that a value returned in information 1700 be provided in terms of, for example, a number of physical resource blocks. A metric, or value, determined by a distributed unit, corresponding to a capacity of sharable downlink slice resources associated with the identification information in field 1705A may be provided in field 1715A. Thus, field 1715A may provide a determined, measured, calculated, or configured value indicative of a slice capacity parameter corresponding to sharable downlink slice resources indicated in field 1705A.

In field 1710B, example bandwidth part slice status message information 1700 may indicate slice resource utilization parameter information corresponding to a resource slice indicated in field 1705A. The slice utilization parameter information in field 1710B may indicate that a value returned in information 1700 be provided in terms of, for example, physical resource blocks. A metric, or value, determined by a distributed unit, corresponding to a utilization of sharable downlink slice resources associated with the identification information in field 1705B may be provided in field 1715B. In an embodiment, a metric provided in field 1715B may be given in terms of a percentage of a capacity indicated in field 1715A. For example, if a capacity metric provided in field 1715A is given in terms of a number of physical resource blocks, a utilization metric provided in field 1715B may be a number, or value, 0-100, inclusive, indicative of a percent utilization of the number of physical resource blocks indicated in field 1715A. In another embodiment, a utilization metric provided in field 1715B may comprise a number of physical resource blocks being utilized by one or more user equipment that are currently operating according to a bandwidth part to which information 1700 corresponds. Thus, field 1715B may provide a determined, measured, or calculated value indicative of a slice utilization of sharable downlink slice resources indicated in field 1705B. Similarly, for a bandwidth part comprising uplink resources and defining uplink sharable slice resources, slice resource information 1700 may comprise identification information in field 1705C indicative of the uplink shareable slice resources, fields 1710C and the 1710D may comprise uplink capacity and utilization parameter information, respectively, and fields 1715C and 1715D may comprise uplink capacity and utilization metrics, respectively, corresponding to the uplink shareable slice resources indicated in filed 1705C.

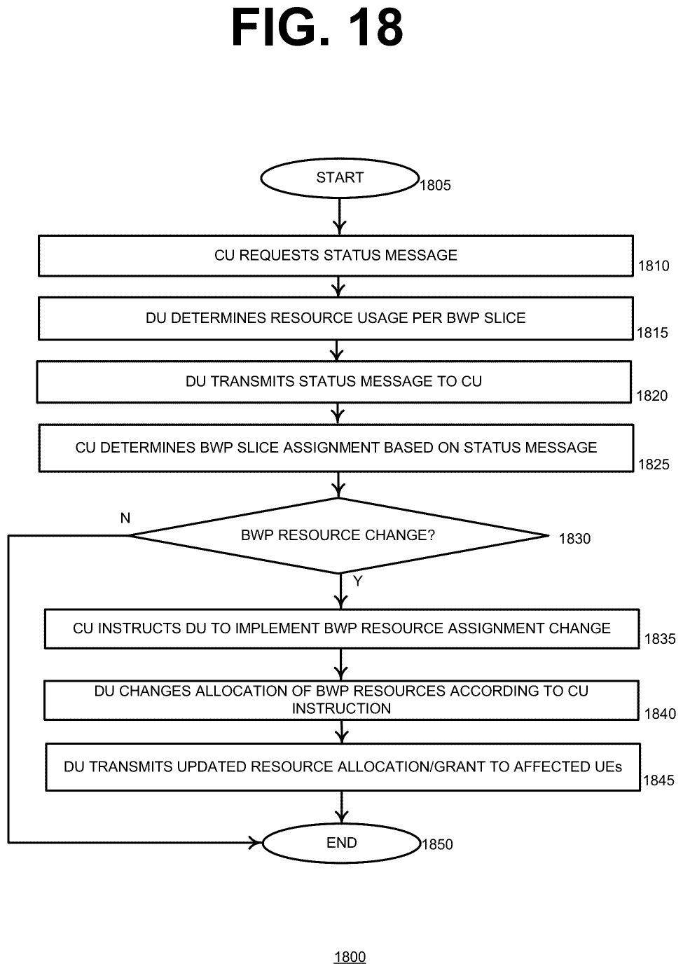

Turning now to FIG. 18, the figure illustrates a flow diagram of an example method 1800 to determine utilization of bandwidth part slice radio resources. Method 1800 begins at act 1805. At act 1810, a centralized unit may request a status message from a distributed unit. Responsive to the request for a status message the distributed unit may determine a radio resource utilization corresponding to a bandwidth part slice, which bandwidth part may be supporting a networking slice, such as, for example, networking resources being used for eMBB traffic or for URLLC traffic. At act 1820, responsive to the request for status message transmitted by the centralized unit at act 1810, the distributed unit may transmit a status message to the centralized unit. At act 1820, the centralized unit may determine assignment of a bandwidth part slice, for example sharable bandwidth part resources, based on a utilization corresponding to the bandwidth part slice as indicated in the status message transmitted by the distributed unit at act 1820. The utilization transmitted by distributed unit to the centralized unit at act 1820 may comprise a measured utilization metric corresponding to a utilization parameter. The utilization transmitted by distributed unit to the centralized unit at act 1820 may comprise a number of physical resource blocks being used by the shareable bandwidth part. The utilization parameter may be a percentage and the utilization metric may be a percentage value based on a number of physical resource blocks being used by the shareable bandwidth part resources with respect to a capacity, or total available physical resource blocks, corresponding to the shareable bandwidth part resources.

At act 1830, the centralized unit may determine whether the utilization metric in the status message that was transmitted by the distributed unit to the centralized unit at act 1820 may warrant sharing at least some shareable bandwidth part resources from one bandwidth part, for example a first bandwidth part supporting eMBB downlink traffic that may be underutilizing resources corresponding to the first bandwidth part according to the status message, to a second bandwidth part, for example a bandwidth part that may be supporting URLLC traffic. The centralized unit may determine whether sharing of shareable bandwidth part resources from one bandwidth part to another may be warranted based on whether a utilization metric, for example a percentage utilization of an available capacity corresponding to the sharable bandwidth part resources satisfies a criterion. For example if a sharing criterion is 50% and the first bandwidth part has sharable resources to which twenty physical resource blocks are assigned, but a utilization metric contained in the status message indicates that only 30% of the shareable resources are being used, and if the status message indicates that the second bandwidth part is utilizing 100% of physical resource blocks assigned to the second bandwidth part, the centralized unit may determine to deactivate, with respect to the first bandwidth part, at least one of the physical resource blocks corresponding to the sharable bandwidth part resources currently assigned to the first bandwidth part, and activate the at least one physical resource block with respect to the second bandwidth part during a resource sharing period. If a determination is made at act 1830 that shareable bandwidth part resources are not to be deactivated with respect to the first bandwidth part and activated with respect to the second bandwidth part, method 1800 advances to act 1850 and ends.

Returning to description of act 1830, if the centralized unit determine to deactivate at least one physical resource block with respect to the first bandwidth part and to activate the at least one physical resource block with respect to the second bandwidth part, at act 1835 the centralized unit may instruct the distributed unit to implement a bandwidth part resource assignment change, with respect to one physical resource block, from the first bandwidth part to the second bandwidth part. At act 1840, the distributed unit may update an allocation of physical resource blocks corresponding to the first bandwidth part such that the at least one physical resource block determined or sharing from the first bandwidth part to the second bandwidth part is deactivated with respect to the first bandwidth part and is activated with respect to the second bandwidth part. At act 1845, the distributed unit may transmit, via downlink control information signaling, an updated resource allocation message to affected user equipment devices. For example, user equipment operating according to the first bandwidth part may be notified that the at least one physical resource block that has been deactivated with respect to the first bandwidth part has been deactivated for a resource sharing period, and user equipment operating according to the second bandwidth part may be notified that the at least one physical resource block has been granted to the user equipment operating according to the second bandwidth part for the resource sharing period. Method 1800 advances to act 1850 and ends.

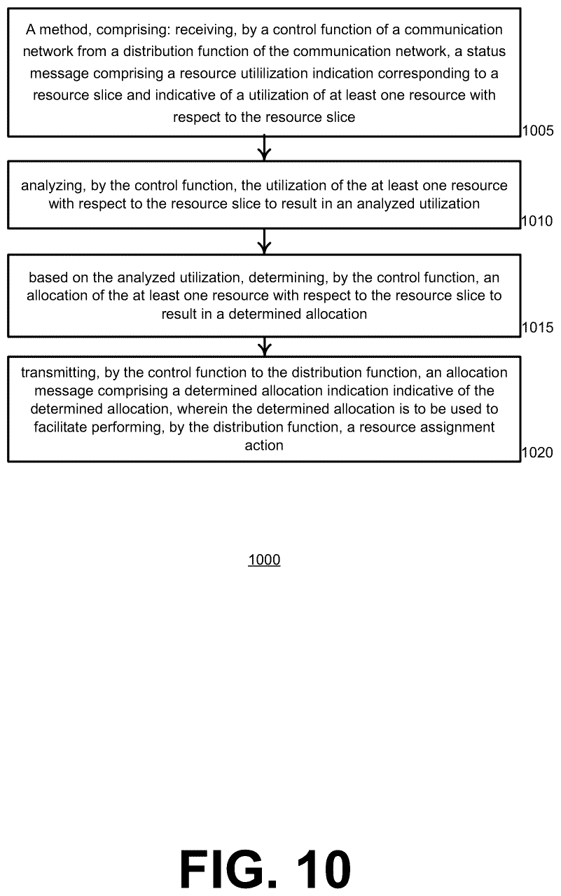

Turning now to FIG. 10, the figure illustrates an example embodiment method 1000 comprising at block 1005 receiving, by a control function of a communication network from a distribution function of the communication network, a status message comprising a resource utilization indication corresponding to a resource slice and indicative of a utilization of at least one resource with respect to the resource slice; at block 1010 analyzing, by the control function, the utilization of the at least one resource with respect to the resource slice to result in an analyzed utilization; at block 1015 based on the analyzed utilization, determining, by the control function, an allocation of the at least one resource with respect to the resource slice to result in a determined allocation; and at block 1020 transmitting, by the control function to the distribution function, an allocation message comprising a determined allocation indication indicative of the determined allocation, wherein the determined allocation is to be used to facilitate performing, by the distribution function, a resource assignment action.

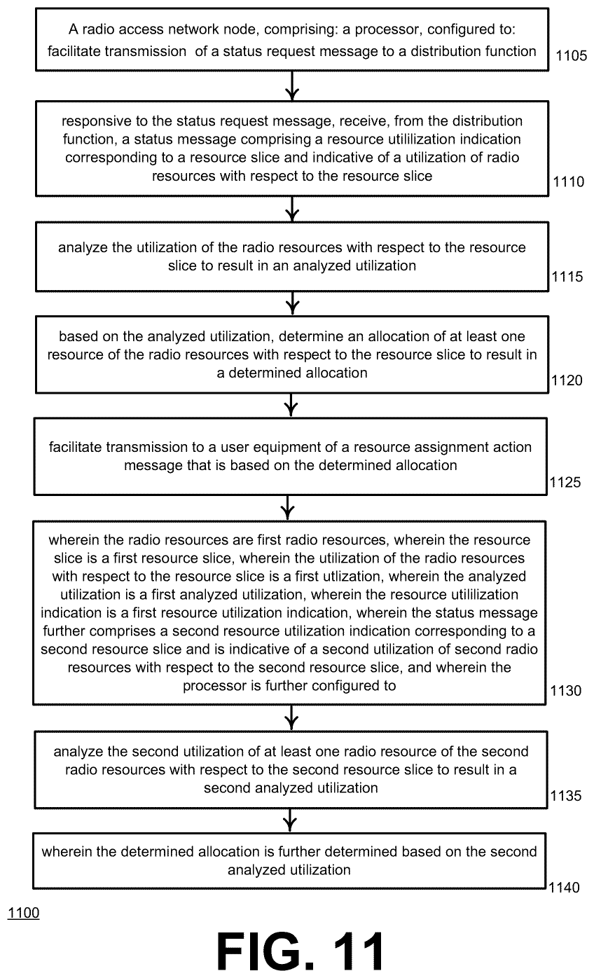

Turning now to FIG. 11, the figure illustrates an example radio access network node, comprising at block 1105 a processor configured to facilitate transmission of a status request message to a distribution function; at block 1110 responsive to the status request message, receive, from the distribution function, a status message comprising a resource utilization indication corresponding to a resource slice and indicative of a utilization of radio resources with respect to the resource slice; at block 1115 analyze the utilization of the radio resources with respect to the resource slice to result in an analyzed utilization; at block 1120 based on the analyzed utilization, determine an allocation of at least one resource of the radio resources with respect to the resource slice to result in a determined allocation; at block 1125 facilitate transmission to a user equipment of a resource assignment action message that is based on the determined allocation; at block wherein the radio resources are first radio resources, wherein the resource slice is a first resource slice, wherein the utilization of the radio resources with respect to the resource slice is a first utilization, wherein the analyzed utilization is a first analyzed utilization, wherein the resource utilization indication is a first resource utilization indication, wherein the status message further comprises a second resource utilization indication corresponding to a second resource slice and is indicative of a second utilization of second radio resources with respect to the second resource slice, and wherein the processor is further configured to, at block 1135 analyze the second utilization of at least one radio resource of the second radio resources with respect to the second resource slice to result in a second analyzed utilization; and at block 1140 wherein the determined allocation is further determined based on the second analyzed utilization.

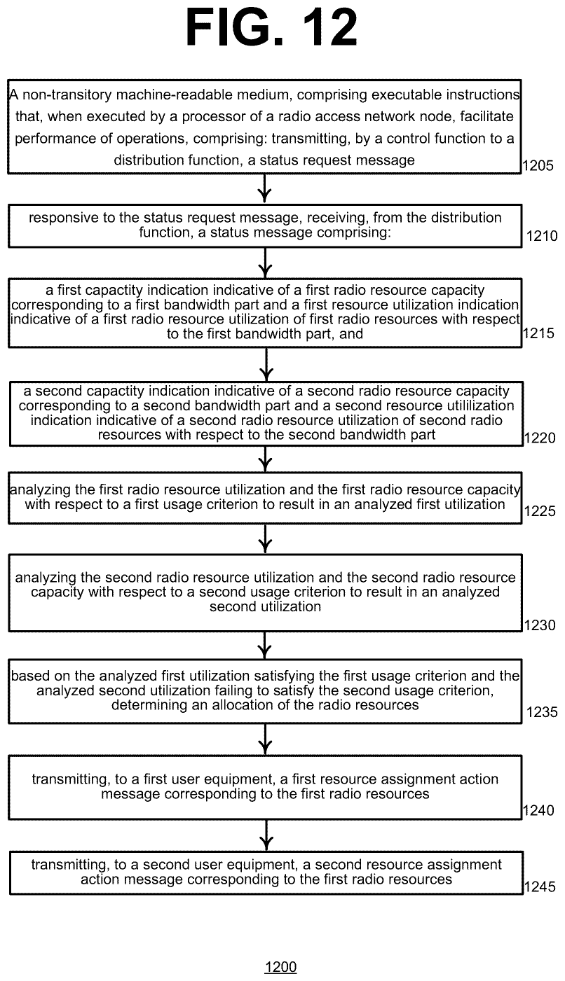

Turning now to FIG. 12, the figure illustrates a non-transitory machine-readable medium 1200 comprising at block 1205 executable instructions that, when executed by a processor of a radio access network node, facilitate performance of operations, comprising transmitting, by a control function to a distribution function, a status request message; at block 1210 responsive to the status request message, receiving, from the distribution function, a status message comprising, at block 1215 a first capacity indication indicative of a first radio resource capacity corresponding to a first bandwidth part and a first resource utilization indication indicative of a first radio resource utilization of first radio resources with respect to the first bandwidth part, and at block 1220 a second capacity indication indicative of a second radio resource capacity corresponding to a second bandwidth part and a second resource utilization indication indicative of a second radio resource utilization of second radio resources with respect to the second bandwidth part; at block 1225 analyzing the first radio resource utilization and the first radio resource capacity with respect to a first usage criterion to result in an analyzed first utilization; at block 1230 analyzing the second radio resource utilization and the second radio resource capacity with respect to a second usage criterion to result in an analyzed second utilization; at block 1235 based on the analyzed first utilization satisfying the first usage criterion and the analyzed second utilization failing to satisfy the second usage criterion, determining an allocation of the radio resources; at block 1240 transmitting, to a first user equipment, a first resource assignment action message corresponding to the first radio resources; and at block 1245 transmitting, to a second user equipment, a second resource assignment action message corresponding to the first radio resources.

In order to provide additional context for various embodiments described herein, FIG. 13 and the following discussion are intended to provide a brief, general description of a suitable computing environment 1300 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors and may include a cache memory. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

Computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and an optical disk drive 1320 (e.g., which can read or write from a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid-state drive (SSD) could be used in addition to, or in place of, an HDD 1310. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can comprise a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are examples and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

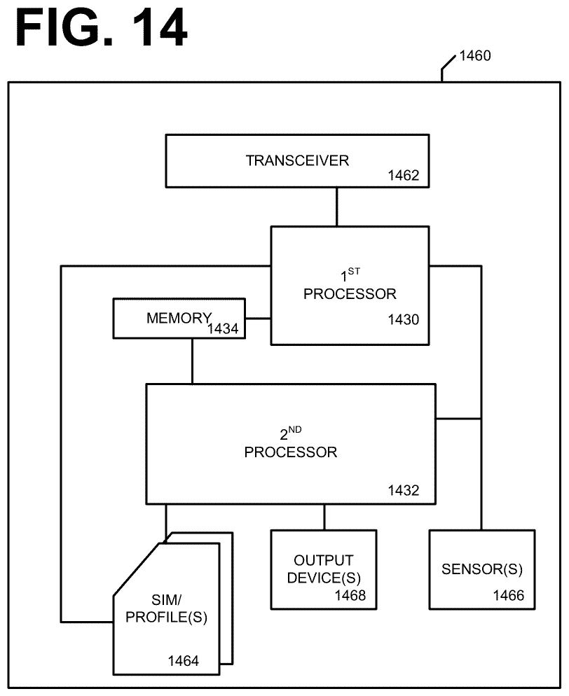

Turning now to FIG. 14, the figure illustrates a block diagram of an example UE 1460. UE 1460 may comprise a smart phone, a wireless tablet, a laptop computer with wireless capability, a wearable device, a machine device that may facilitate vehicle telematics, and the like. UE 1460 comprises a first processor 1430, a second processor 1432, and a shared memory 1434. UE 1460 includes radio front end circuitry 1462, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1462 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 14, UE 1460 may also include a SIM 1464, or a SIM profile, which may comprise information stored in a memory (memory 34 or a separate memory portion), for facilitating wireless communication with RAN 105 or core network 130 shown in FIG. 1. FIG. 14 shows SIM 1464 as a single component in the shape of a conventional SIM card, but it will be appreciated that SIM 1464 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1464 and another device, which may be a component of RAN 105 or core network 130 shown in FIG. 1). A SIM profile 1464 may also comprise identifying information that is unique to the SIM, or SIM profile, such as, for example, an International Mobile Subscriber Identity (“IMSI”) or information that may make up an IMSI.

SIM 1464 is shown coupled to both the first processor portion 1430 and the second processor portion 1432. Such an implementation may provide an advantage that first processor portion 30 may not need to request or receive information or data from SIM 1464 that second processor 1432 may request, thus eliminating the use of the first processor acting as a ‘go-between’ when the second processor uses information from the SIM in performing its functions and in executing applications. First processor 1430, which may be a modem processor or baseband processor, is shown smaller than processor 1432, which may be a more sophisticated application processor, to visually indicate the relative levels of sophistication (i.e., processing capability and performance) and corresponding relative levels of operating power consumption levels between the two processor portions. Keeping the second processor portion 1432 asleep/inactive/in a low power state when UE 1460 does not need it for executing applications and processing data related to an application provides an advantage of reducing power consumption when the UE only needs to use the first processor portion 1430 while in listening mode for monitoring routine configured bearer management and mobility management/maintenance procedures, or for monitoring search spaces that the UE has been configured to monitor while the second processor portion remains inactive/asleep.

UE 1460 may also include sensors 1466, such as, for example, temperature sensors, accelerometers, gyroscopes, barometers, moisture sensors, and the like that may provide signals to the first processor 1430 or second processor 1432. Output devices 1468 may comprise, for example, one or more visual displays (e.g., computer monitors, VR appliances, and the like), acoustic transducers, such as speakers or microphones, vibration components, and the like. Output devices 1468 may comprise software that interfaces with output devices, for example, visual displays, speakers, microphones, touch sensation devices, smell or taste devices, and the like, that are external to UE 1460.

The following glossary of terms given in Table 1 may apply to one or more descriptions of embodiments disclosed herein.

TABLE 2

| Term | Definition |
|---|---|
| UE | User equipment |
| WTRU | Wireless transmit receive unit |
| RAN | Radio access network |
| QoS | Quality of service |
| DRX | Discontinuous reception |
| DTX | Discontinuous transmission |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |
| PRB | Physical resource block |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by a control function of a communication network from a distribution function of the communication network, a status message comprising a resource utilization indication corresponding to a resource slice and indicative of a utilization of at least one resource with respect to the resource slice;
analyzing, by the control function, the utilization of the at least one resource with respect to the resource slice to result in an analyzed utilization;
based on the analyzed utilization, determining, by the control function, an allocation of the at least one resource with respect to the resource slice to result in a determined allocation; and
transmitting, by the control function to the distribution function, an allocation message comprising a determined allocation indication indicative of the determined allocation, wherein the determined allocation is to be used to facilitate performing, by the distribution function, a resource assignment action.

2. The method of claim 1, wherein the at least one resource is a physical resource block.

3. The method of claim 1, wherein the at least one resource is a portion of a physical resource block.

4. The method of claim 1, wherein the resource slice is a first resource slice, wherein the at least one resource is a first resource of the at least one resource corresponding to a first resource type associated with a first bandwidth part that facilitates the first resource slice, and wherein the determined allocation comprises a deactivation of the first resource of the at least one resource with respect to the first bandwidth part and an activation of a second resource of the at least one resource with respect to a second bandwidth part that facilitates a second resource slice.

5. The method of claim 4, wherein the resource assignment action is specified to comprise:
generating, by the distribution function, a deactivation message, to be transmitted to at least one first user equipment corresponding to the first resource slice, indicative that the first resource of the at least one resource has been deactivated with respect to the first resource slice; and
generating, by the distribution function, an activation message, to be transmitted to at least one second user equipment corresponding to the second resource slice, indicative that the second resource of the at least one resource has been activated with respect to the second resource slice.

6. The method of claim 4, wherein the second resource of the at least one resource corresponds to a second resource type associated with the second bandwidth part, and wherein the first resource type and the second resource type are different.

7. The method of claim 6, wherein the first resource of the at least one resource comprises at least one first physical resource block having a first size corresponding to the first bandwidth part, and wherein the second resource of the at least one resource comprises at least one second physical resource block having a second size corresponding to the second bandwidth part.

8. The method of claim 1, wherein the resource slice is a first resource slice, wherein a first bandwidth part facilitates the first resource slice, wherein a second bandwidth part facilitates a second resource slice, and wherein the at least one resource is sharable between the first bandwidth part and the second bandwidth part.

9. The method of claim 1, wherein the control function and the distribution function are components of a radio access network node of the communication network.

10. The method of claim 1, wherein the control function is a component of a radio access network node intelligent controller of the communication network.

11. A radio access network node, comprising:
a processor, configured to:
facilitate transmission of a status request message to a distribution function;
responsive to the status request message, receive, from the distribution function, a status message comprising a resource utilization indication corresponding to a resource slice and indicative of a utilization of radio resources with respect to the resource slice;
analyze the utilization of the radio resources with respect to the resource slice to result in an analyzed utilization;
based on the analyzed utilization, determine an allocation of at least one resource of the radio resources with respect to the resource slice to result in a determined allocation; and
facilitate transmission to a user equipment of a resource assignment action message that is based on the determined allocation.

12. The radio access network node of claim 11, wherein the processor corresponds to a control function.

13. The radio access network node of claim 11, wherein the status message further comprises a capacity corresponding to the resource slice, and wherein the determined allocation is further determined based on the capacity corresponding to the resource slice.

14. The radio access network node of claim 11, wherein the radio resources are first radio resources, wherein the resource slice is a first resource slice, wherein the utilization of the radio resources with respect to the resource slice is a first utilization, wherein the analyzed utilization is a first analyzed utilization, wherein the resource utilization indication is a first resource utilization indication, wherein the status message further comprises a second resource utilization indication corresponding to a second resource slice and is indicative of a second utilization of second radio resources with respect to the second resource slice, and wherein the processor is further configured to:
analyze the second utilization of at least one radio resource of the second radio resources with respect to the second resource slice to result in a second analyzed utilization,
wherein the determined allocation is further determined based on the second analyzed utilization.

15. The radio access network node of claim 14, wherein the status message further comprises a first capacity corresponding to the first resource slice and a second capacity corresponding to the second resource slice, and wherein the determined allocation is further determined based on the first capacity and the second capacity.

16. A non-transitory machine-readable medium, comprising executable instructions that, when executed by a processor of a radio access network node, facilitate performance of operations, comprising:
transmitting, by a control function to a distribution function, a status request message;
responsive to the status request message, receiving, from the distribution function, a status message comprising:
a first capacity indication indicative of a first radio resource capacity corresponding to a first bandwidth part and a first resource utilization indication indicative of a first radio resource utilization of first radio resources with respect to the first bandwidth part, and
a second capacity indication indicative of a second radio resource capacity corresponding to a second bandwidth part and a second resource utilization indication indicative of a second radio resource utilization of second radio resources with respect to the second bandwidth part;
analyzing the first radio resource utilization and the first radio resource capacity with respect to a first usage criterion to result in an analyzed first utilization;
analyzing the second radio resource utilization and the second radio resource capacity with respect to a second usage criterion to result in an analyzed second utilization;
based on the analyzed first utilization satisfying the first usage criterion and the analyzed second utilization failing to satisfy the second usage criterion, determining an allocation of the radio resources;
transmitting, to a first user equipment, a first resource assignment action message corresponding to the first radio resources; and
transmitting, to a second user equipment, a second resource assignment action message corresponding to the first radio resources.

17. The non-transitory machine-readable medium of claim 16, wherein the first resource assignment action message comprises an indication that the first radio resources are to be deactivated with respect to the first bandwidth part, and wherein the second resource assignment action message comprises an indication that the first radio resources are to be activated with respect to the second bandwidth part.

18. The non-transitory machine-readable medium of claim 16, wherein the first usage criterion is satisfied by the first radio resource utilization being a first percentage of the first radio resources that is lower than the first usage criterion, and wherein the second usage criterion is satisfied by the second radio resource utilization being a second percentage of the second radio resources that is higher than the second usage criterion.

19. The non-transitory machine-readable medium of claim 18, wherein at least one of the first usage criterion or the second usage criterion is a first percentage of utilization of the first radio resource capacity or a second percentage of utilization of the second radio resource capacity.

20. The non-transitory machine-readable medium of claim 16, wherein the first radio resource capacity is a first configured number of physical resource blocks usable by the first bandwidth part, wherein the second radio resource capacity is a second configured number of physical resource blocks usable by the second bandwidth part, wherein the first radio resource utilization of the first radio resources with respect to the first bandwidth part is a first used number of the first configured number of physical resource blocks used by the first bandwidth part, and wherein the second radio resource utilization of the second radio resources with respect to the second bandwidth part is a second used number of the second configured number of physical resource blocks used by the second bandwidth part.
